(19) United States
(12) Patent Application Publication
(10) Pub. No.: US 2026/0215418 A1
(43) Pub. Date: Jul. 30, 2026

(54) HYDROCARBON ALCOHOLS AND THEIR DERIVATIVES AS SYNERGISTS IN PESTICIDE ACTIVITY

(71) Applicant: VEBI ISTITUTO BIOCHIMICO S.R.L., Borgoricco (IT)

(72) Inventors: Luigi BAZZOLO, Borgoricco (IT); Elisabetta GIANECCHINI, Borgoricco (IT); Oreste PICCOLO, Borgoricco (IT); Stefano SCAPINELLO, Borgoricco (IT); Alessandra TURETTA, Borgoricco (IT); Roberto VESCOVO, Borgoricco (IT)

(73) Assignee: VEBI ISTITUTO BIOCHIMICO S.R.L., Borgoricco (IT)

(21) Appl. No.: 19/124,091

(22) PCT Filed: Oct. 27, 2023
(86) PCT No.: PCT/EP2023/080039

§ 371 Date: Apr. 24, 2025

(30) Foreign Application Priority Data
Oct. 28, 2022 (IT) 102022000022224

(51) Int. Cl. A01N 31/02; A01N 43/16; A01N 43/50; A01N 53/00; A01N 57/16; A01P 7/04

(52) U.S. Cl. CPC A01N 31/02; A01N 43/16; A01N 43/50; A01N 53/00; A01N 57/16; A01P 7/04

(57) ABSTRACT

A first object of the present invention is an insecticidal composition comprising: (i) An active substance that is at least one component with adulticidal and/or larvicidal insecticidal activity and/or at least one component with insect growth regulation activity; (ii) At least one synergist which is a hydrocarbon alcohol having between 6 and 24 carbon atoms, linear or branched, saturated or unsaturated or derived thereof or its derivatives, such derivatives being carbonates or esters of such alcohols. A method for insect disinfestation, which includes the exposure of the area of interest or target insects to said at least one hydrocarbon alcohol or derivatives and to at least one active insecticide, simultaneously or within 5 hours, is also the subject of this invention.

### STATE OF THE ART

Insects, fungi and plants such as mono- or di-cotyledons have developed multiple self-defense mechanisms against the action of pesticides. These include the production of metabolic substances capable to partially or totally neutralize the active ingredients to which they are exposed or to transform pesticides into non-active substances by bio catalyzed processes. In practice, these mechanisms result in the low or no effectiveness of these active ingredients.

The cytochrome P450 family and enzymes belonging to the category of esterases are among the main tools used by insects to make insecticides harmless. The metabolic pathway of action is based on the detoxification and degradation of active molecules. This pathway also acts as an enhancement of the general metabolism of the insect.

Cytochrome P450 and esterases are the target of a well-known and widely used synergist: Piperonyl Butoxide (PBO), a semisynthetic product, which however has a certain degree of toxicity, as well as being poorly biodegradable. Moreover, the effect of PBO is not comparable between different species, its action being exerted in a different manner on the different P450 cytochromes and on the different esterases present in insects, fungi, weeds and various pathogens.

Many countries banned the use of PBO in plant protection products intended for agriculture, in particular organic farming. Although PBO is very effective, there is, therefore, the need for its replacement with natural products or natural products derivatives, which are less toxic to the environment and of wider applicability.

Fatty acids have been widely described for their use in pesticides. By way of example, U.S. Pat. No. 4,975,110 describes an environmentally friendly herbicidal composition comprising a fatty acid as active ingredient and one or more surfactants. The fatty acids of these herbicidal compositions include pelargonic acid which can be used alone or as a predominant component of a mixture of fatty acids such as caprylic, lauric or undecanoic acid.

U.S. Pat. No. 5,700,473 describes a non-phytotoxic Pyrethrin-based arthropodicidal, comprising a triglyceride derived from vegetable seed oils, a pyrethrum extract and one or more surfactants.

U.S. Pat. No. 7,820,594 describes pesticide compositions that are particularly useful as fungicidal or herbicidal compositions, including one or more fatty acids and one or more organic acid other than a fatty acid. When combined with a fatty acid, organic acid acts as a powerful synergist for fatty acid.

U.S. Pat. No. 8,993,004 and WO2010115065 describe compositions that include at least one pesticide and a mixture of unsaturated C12-C26 fatty acids and/or their salts and C6-C₁₄ saturated fatty acids and/or their salts, of vegetable origin.

U.S. Pat. No. 8,097,631 describes a fungicidal composition that contains, in addition to the active substance, Cyprodinil, an unsaturated C18 fatty acid selected from oleic acid, linoleic acid and linolenic acid.

U.S. Pat. No. 11,122,801 describes the use of mono and polyunsaturated acids C6 to C24 or their derivatives, in pesticide formulations as enzyme inhibitors, in particular cytochrome P450 and esterases.

EP3346835 describes an insecticidal or acaricide composition comprising the arginine salt of a fatty acid, where the fatty acid comprises one or more unsaturated fatty acids having 14 to 22 carbon atoms and one or more fatty acids having 8 to 18 carbon atoms, where the ratio by weight of unsaturated fatty acids having 14 to 22 carbon atoms and saturated fatty acids having 8 at 18 carbon atoms is at least 1.

WO2018233869 describes insecticidal formulations including naturally occurring Pyrethrins mixtures and C16 to C24 unsaturated fatty acids that increase the potency of natural Pyrethrins.

WO2020109729 describes a composition comprising at least one linear or branched w-hydroxylated fatty acid or its derivative, or a mixture of such linear or branched w-hydroxylated fatty acids or their derivatives, and their use for the protection of plants against pathogens.

WO2020187656 describes the use of new combinations of some active ingredients and at least one or more fatty acids or their derivatives for the control of animal and microbial parasites.

CN112075428 describes the use of linoleic acid as a pesticide.

WO2021099271 and WO2021175947 describe pesticide compositions comprising one or more C12-C24 fatty acids, their salts, esters or mixtures of these substances and at least one additional active agent as a pesticide.

JP2021165303 describes a pest control composition comprising natural Pyrethrins and at least one naturally derived component belonging to one of the following classes: sesquiterpene lactones; sterols; flavonoids; fatty acids; monoterpenes; sesquiterpenes; triterpenols; alcohols (seril alcohol, (Z)-3-esen-1-ol, 1-octen-3-ol); alkanes, alkenes and some derivatives containing an aromatic group; carotenoids; ketones; esters ((Z)-3-hexen-1-ol-acetate, 1-octen-3-ol-acetate, 3-cyclohexen-1-ol-acetate, 3-hexenyl-2-methylbutanoate, 3-hexenyl-3-methylbutanoate, hexyl acetate, isoamyl acetate, β-phenylethyl isovalerate); vegetable oils.

U.S. Pat. No. 5,288,483, WO0158260, EP2364590, CN102370599, WO2013093647 describe insecticide formulations comprising, together with the active ingredients, naturally and synthetically derived fatty materials including alcohols, hydroxy alcohols and their derivatives such as esters and carbonates and mixtures thereof, having carbon chain lengths of from about 8 to about 22. These alcohols and derivatives are included among the formulative excipients, no any indication, no any suggestion is given in the documents of an active role exerted by these ingredients.

GB2095109 describes an insecticidal composition comprising one or more pyrethroid insecticides and a long-chain fatty alkanol. The concentration of alkanol is from 0.01 to 2%, preferably from 0.02 to 1% by weight, and the preferred fatty alkanol is 1-hexadecanol. Also in this case, no active role is described, not suggested for long-chain fatty alkanols. Moreover, a pyrethroid synergist, such as PBO, may also be included in the compositions, taking away the man skilled in the art from using the same fatty alkanols as active ingredients.

CN106857635 describes a household insecticide characterized in that the composition of the insecticide is as follows: 2-10 parts by weight of PBO, 3-10 parts by weight of the pyrethrum derivative, tetramethrin, 2-10 parts by weight of a synergist, 70-90 parts by weight of water, where the synergist is n-butanethiol and octyldodecanol with a mass ratio from 1 to 2 or from 2 to 1. The simultaneous presence of butanethiol and octyldodecanol is required. A specific proportion of octyldodecanol can promote the penetration of n-butanethiol and effectors and improve the insecticidal effect.

EP3964068 describes a glycol compound having a hydroxyl group bonded to each of two adjacent carbon atoms of an alkane having 4 to 7 carbon atoms, more specifically 1,2 hexanediol, as an insecticidal efficacy enhancer capable to increase the vaporization of the product, diffused by being heated. The content of the glycol compound in the water-based insecticidal composition is 2 to 70% by mass, and more preferably 6 to 60% by mass. When alternative diols to 1,2 hexanediol were tested, no similar effect has been observed.

### DETAILED DESCRIPTION OF THE INVENTION

The present invention concerns compositions comprising at least one hydrocarbon alcohol having from 6 to 24 carbon atoms, linear or branched, saturated or unsaturated, or its derivatives in association with at least one component with insecticidal and/or insect growth regulating activity, said derivatives being carbonates or esters of said alcohols. In one embodiment, said at least one alcohol is an alcohol of general formula (I)

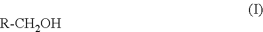

where R is a hydrocarbon chain having 5 to 23, or 7 to 19 carbon atoms, linear or branched, saturated or containing one or more double bonds. In an embodiment, at least one of said carbon atoms on said hydrocarbon chain is substituted by an OH group. These derivatives are selected in the group comprising esters of general formula (II)

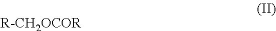

where R has the above meaning, R′ is a linear or branched alkyl radical, saturated or unsaturated, having from 1 to 6 carbon atoms; optionally one or more of said carbon atoms on said hydrocarbon chain R′ being replaced by an OH group; carbonates of general formula (III)

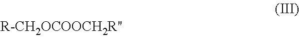

where R has the above meaning, R″ is equal to or different from R and if different it is an alkyl radical, linear or branched, saturated or unsaturated, having from 1 to 23 carbon atoms, optionally one or more of said C being OH substituted.

In one embodiment, said at least one pesticide is selected in the group that comprises: natural Pyrethrins, synthetic pyrethroids, among them Cypermethrin, Permethrin, Deltamethrin, Tetramethrin, Prallethrin, neonicotinoids, such as Imidacloprid biopesticides, spinosyn, phosphoric esters such as Azamethiphos, oxadiazines, phenylpyrazoles, avermectins, Neem oil or azadirachtins as well.

In one embodiment, the compound of general formula (I) or its derivatives (II) or (III) is present in that composition in a weight ratio of between 0.4 and 10.0 of the active substance, preferably between 0.6 and 7.0, more preferably 1.0 and 6.0 and in a molar ratio between 1.0 and 14.0 of the active substance, preferably between 1.5 and 10.0. These compositions are formulated according to the state of the art, such as, for example, emulsions, solutions, encapsulated products, powders, bait.

In one embodiment, this composition is claimed for use as a pesticide.

In one embodiment, said composition is used on target insects.

In one embodiment, said composition is applied to surfaces to prevent insects from depositing on them.

In a further embodiment, a pesticide method is claimed, comprising the exposure of the area of interest, or of the target insects, to at least one hydrocarbon alcohol having from 6 to 24 carbon atoms, linear or branched, saturated or unsaturated, or its derivatives, such derivatives being carbonates or esters of those alcohols, and to at least one active substance with adulticidal and/or larvicide insecticidal and/or insect growth regulating activity, wherein the exposure to said at least one synergist and to said least one pesticide is simultaneous, or the exposure to said at least one synergist precedes exposure to said at least one pesticide up to 5 hours, or up to 3 hours, or 1 hour.

In the context of the present invention, alcohol of general formula (I) or its derivatives (II) and (III) are also defined “synergist”.

The area of interest is, for example, a surface, such as the floor of a room, or a curtain, or any surfaces requiring such a treatment.

In one embodiment, when such exposure to at least one synergist and at least one pesticide occurs simultaneously, said at least one alcohol and said at least one pesticide are formulated in the free part of the same formulation.

In one embodiment, the subsequential exposure is obtained by time-release formulations according to the art. As an example, by encapsulating said at least one active ingredient and leaving said at least one synergist in the free part of the formulation.

In one embodiment, said alcohol or alcohol derivative is present in said composition in a weight ratio between 0.4 and 20 with respect to said at least one active ingredient.

In one embodiment, said alcohol or alcohol derivative is present in said composition in a weight ratio which is below 2 with respect to said at least one active ingredient.

In one embodiment, wherein said target insects are Musca domestica, said active ingredient is Cypermethrin, Spinosad, synthetic or natural Pyrethrins, Azamethiphos, Imidacloprid, and said alcohol or alcohol derivative is selected in the group comprising 1,2-hexandiol, 2-ethylexyl carbonate, dioctyl carbonate, oleyl acetate, oleic alcohol, 2-octyl dodecanol, dodecanol, 1,2-octandiol, 1,8-octandiol, 1,2-dodecandiol.

In one embodiment, wherein said target insects are Musca domestica, said active ingredient is Cypermethrin and said alcohol or alcohol derivative is selected in the group comprising 1,2-hexandiol, 2-ethylexyl carbonate, dioctyl carbonate, Oleyl acetate, Oleic alcohol, 2-octyl dodecanol, dodecanol, 1,2-octandiol, 1,8-octandiol, 1,2-dodecandiol.

In one embodiment, wherein said target insects are Musca domestica, said active ingredient is Spinosad and said alcohol or alcohol derivative is selected in the group comprising oleic alcohol, 1,2-hexandiol, oleyl acetate.

In one embodiment, wherein said target insects are Musca domestica, said active ingredient is Azamethiphos and said alcohol or alcohol derivative is selected in the group comprising oleic alcohol, 1,2-hexandiol, oleyl acetate.

In one embodiment, wherein said target insects are Musca domestica, said active ingredient are Pyrethrins and said alcohol or alcohol derivative is selected in the group comprising oleic alcohol, 1,2-hexandiol.

In one embodiment, wherein said target insects are of the genus Blatta sp., said active ingredient is selected in the group comprising Cypermethrin, Imidacloprid, synthetic or natural Pyrethrins, Azamethiphos and said alcohol or alcohol derivative is selected in the group comprising 1,2-hexandiol, 1,2-octandiol, 1,8-octandiol, 1,2-dodecandiol., 1,12-dodecandiol, 2-ethylexyl carbonate, dioctyl carbonate, oleyl acetate, dodecyl acetate, n-Octyl acetate, oleic alcohol, octanol, hexadecanol, tetradecanol, dodecanol, 2-octyl dodecanol.

In one embodiment, wherein said target insects are Blatta lateralis, said active ingredient is Cypermethrin and said alcohol is 1,2-hexandiol.

In one embodiment, wherein said target insects are Blatta orientalis, said active ingredient is Cypermethrin and said alcohol or alcohol derivatives is 1,2-hexandiol, or 2-ethylexyl carbonate or dioctyl carbonate, oleyl acetate, oleic alcohol, or 1,2-octandiol.

In one embodiment, wherein said target insects are Blatta orientalis, said active ingredient are Pyrethrins and said alcohol is oleic alcohol.

In one embodiment, wherein said target insects are Blatta orientalis, said active ingredient is Azamethiphos and said alcohol is oleic alcohol, or oleyl acetate.

In one embodiment, wherein said target insects are Blatta orientalis, said active ingredient is Imidacloprid and said alcohol is oleic alcohol.

In one embodiment, wherein said target insects are Blattella germanica, said active ingredient is Imidacloprid and said alcohol is oleic alcohol.

Advantageously, the synergistic effect surprisingly demonstrated with the composition and/or method according to this invention allows to reduce the amount of active ingredients used in pesticide formulations, with consequent cost reduction, lower environmental impact, lower risk of resistance onset.

The non-exhaustive examples, given below, describe the results obtained using formulations according to the present invention or formulations of the known art, for comparative purpose.

### EXAMPLES

### Compositions Used

### Composition 1 (Comparative):

Pyrethrins in acetone, 0.70 mg/ml. Volume dispensed on 400 cm² tile: 1 ml, Pyrethrins=17.50 mg/m².

### Composition 2 (Comparative):

Pyrethrins in acetone, 0.40 mg/ml. Volume dispensed on 400 cm² tile: 1 ml, Pyrethrins=10.00 mg/m².

### Composition 3 (Comparative):

Cypermethrin in acetone, 0.45 mg/ml. Volume dispensed on 400 cm² tile: 1 ml, Cypermethrin=11.30 mg/m².

Composition 4a (comparative):

Cypermethrin in acetone, 0.20 mg/ml. Volume dispensed on 400 cm² tile: 1 ml, Cypermethrin=5.00 mg/m².

Composition 4b (comparative):

Cypermethrin in acetone, 0.03 mg/ml. Volume dispensed on 400 cm² tile: 1 ml, Cypermethrin=0.80 mg/m².

Composition 5a (according to the invention):

Microencapsulated water-based 2.0% Pyrethrins, 7.4% oleic alcohol (titre 85.0%). Dilution formulated in water: 5.0%. Final concentration: 1 mg/ml Pyrethrins, 3.70 mg/ml oleic alcohol 85.0%. Volume dispensed on 400 cm² tile: 1 ml, Pyrethrins=25.00 mg/m², oleic alcohol 85.0%=92.50 mg/m².

Composition 5b (according to the invention):

Microencapsulated water-based 2.0% Pyrethrins, 7.4% oleic alcohol (titre 85.0%). Dilution formulated in water: 4.0%. Final concentration 0.80 mg/ml Pyrethrins, 2.96 mg/ml oleic alcohol 85.0%. Volume dispensed on 400 cm² tile: 1 ml, Pyrethrins=20.00 mg/m², oleic alcohol 85.0%=74.00 mg/m².

Composition 6a (comparative):

Microencapsulated water-based 2.0% Pyrethrins. Dilution formulated in water: 5.0%. Final concentration: 1.00 mg/ml Pyrethrins. Volume dispensed on 400 cm² tile: 1 ml, Pyrethrins=25.00 mg/m².

Composition 6b (comparative):

Microencapsulated water-based 2.0% Pyrethrins. Dilution formulated in water: 4.0%. Final concentration: 0.80 mg/ml Pyrethrins. Volume dispensed on 400 cm² tile: 1 ml, Pyrethrins=20.00 mg/m².

Composition 7a (comparative):

Microencapsulated water-based 2.1% Pyrethrins, 10.0% PBO. Dilution formulated in water: 4.76%. Final concentration 1 mg/ml Pyrethrins, 4.76 mg/ml PBO. Volume dispensed on 400 cm² tile: 1 ml, Pyrethrins=25.00 mg/m², PBO=119.00 mg/m².

Composition 7b (comparative):

Microencapsulated water-based 2.1% Pyrethrins, 10.0% PBO. Dilution formulated in water: 3.8%. Final concentration: 0.80 mg/ml Pyrethrin, 3.80 mg/ml PBO. Volume dispensed on 400 cm² tile: 1 ml, Pyrethrins=20.00 mg/m², PBO=95.00 mg/m².

### Composition 8 (Comparative):

Technical oleic alcohol (85.0% content) in acetone, between 0.30 and 7.00 mg/ml. The concentration is determined according to the use in combination with an active ingredient so as to obtain a delivered dose of oleic alcohol 85.0% in mg/m² equal to 10 times by weight of the insecticide, in the case of Pyrethrins and 1.5 times by weight when used in combination with Cypermethrin. Volume dispensed on 400 cm² tile: 1 ml. Especially:

Composition 8a (comparative):

Technical oleic alcohol (85.0% content) in acetone 7.00 mg/ml, corresponding to 175.00 mg/m².

Composition 8b (comparative):

Technical oleic alcohol (85.0% content) in acetone 4.00 mg/ml, corresponding to 100.00 mg/m².

Composition 8c (comparative):

Technical oleic alcohol (85.0% content) in acetone 0.68 mg/ml, corresponding to 16.88 mg/m².

Composition 8d (comparative):

Technical oleic alcohol (85.0% content) in acetone 0.30 mg/ml, corresponding to 7.50 mg/m².

### Composition 9 (Comparative):

PBO in acetone between 0.30 and 0.68 mg/ml. The concentration is chosen according to the amount of active substance used in the example to have a delivered dose of PBO in mg/m² equal to 1.5 times by weight in the case of Cypermethrin. Especially:

Composition 9a (comparative):

PBO in acetone 0.68 mg/ml, corresponding to 16.88 mg/m².

Composition 9b (comparative):

PBO in acetone 0.30 mg/ml, corresponding to 7.50 mg/m².

### Composition 10 (Comparative):

Mixture of oleic acid/linoleic acid (75/12) in acetone. The concentration is between 0.30 and 0.68 mg/ml and is chosen according to the amount of active ingredient used in the example to have a delivered dose of oleic acid/linoleic acid mixture (75/12) in mg/m² equal to 1.5 times by weight in the case of Cypermethrin. Especially:

Composition 10a (comparative):

Oleic acid/linoleic acid (75/12) in acetone 0.68 mg/ml, corresponding to 16.88 mg/m².

Composition 10b (comparative): Oleic acid/linoleic acid (75/12) in acetone 0.30 mg/ml, corresponding to 7.50 mg/m².

### Composition 11 (Comparative):

Oleic alcohol (95.0% content) in acetone. The concentration used, between 0.30 and 0.68 mg/ml, is chosen according to the amount of active ingredient used in the example to have a delivered dose of oleic alcohol 95.0% in mg/m² equal to 1.5 times by weight in the case of Cypermethrin. Especially:

Composition 11a (comparative):

Oleic alcohol (95.0% content) in acetone 0.68 mg/ml, corresponding to 16.88 mg/m².

Composition 11b (comparative):

Oleic alcohol (95.0% content) in acetone 0.30 mg/ml, corresponding to 7.50 mg/m².

### Composition 12 (Comparative):

2-Octyl-dodecanol alcohol in acetone. The concentration used, between 0.30 and 0.68 mg/ml, is chosen according to the amount of active ingredient used in the example to have a delivered dose of 2-octyl-decanol alcohol in mg/m² equal to 1.5 times by weight in the case of Cypermethrin. Especially:

Composition 12a (comparative):

2-Octyl-dodecanol alcohol in acetone 0.68 mg/ml, corresponding to 16.88 mg/m².

Composition 12b (comparative):

2-Octyl-dodecanol alcohol in acetone 0.30 mg/ml, corresponding to 7.50 mg/m².

### Composition 13 (Comparative):

Tetradecanol in acetone 0.30 mg/ml, concentration chosen according to the amount of active ingredient used in the example to have a delivered dose of tetradecanol in mg/m² equal to 1.5 times by weight in the case of Cypermethrin. Volume dispensed on 400 cm² tile: 1 ml, corresponding to 7.50 mg/m².

### Composition 14 (Comparative):

Hexadecanol in acetone 0.30 mg/ml, concentration chosen according to the amount of active ingredient used in the example to have a delivered dose of hexadecanol in mg/m² equal to 1.5 times by weight in the case of Cypermethrin. Volume dispensed on 400 cm² tile: 1 ml, corresponding to 7.50 mg/m².

### Composition 15 (Comparative):

Octanol in acetone 0.30 mg/ml, concentration chosen according to the amount of active ingredient used in the example to have a delivered dose of octanol in mg/m² equal to 1.5 times by weight in the case of Cypermethrin. Volume dispensed on 400 cm² tile: 1 ml, corresponding to 7.50 mg/m².

### Composition 16 (Comparative):

Dodecanol in acetone 0.30 mg/ml, concentration chosen according to the amount of active ingredient used in the example to have a delivered dose of dodecanol in mg/m² equal to 1.5 times by weight in the case of Cypermethrin. Volume dispensed on 400 cm² tile: 1 ml, corresponding to 7.50 mg/m².

### Composition 17 (Comparative):

Bis(2-ethyl-hexyl)-carbonate in acetone. The concentration, between 0.30 and 0.68 mg/ml, is chosen according to the amount of active ingredient used in the example to have a delivered dose of 2-ethyl-hexylcarbonate in mg/m² equal to 1.5 times by weight in the case of Cypermethrin. Volume dispensed on 400 cm² tile: 1 ml. Particularly:

Composition 17a (comparative):

Bis(2-ethyl-hexyl)-carbonate in acetone 0.68 mg/ml, corresponding to 16.88 mg/m².

Composition 17b (comparative):

Bis(2-ethyl-hexyl)-carbonate in acetone 0.30 mg/ml, corresponding to 7.50 mg/m².

Composition 18 (comparative)

Dioctyl carbonate in acetone. The concentration, between 0.30 and 0.68 mg/ml, is chosen according to the amount of active ingredient used in the example to have a delivered dose of dioctyl carbonate in mg/m² equal to 1.5 times by weight in the case of Cypermethrin. Volume dispensed on 400 cm² tile: 1 ml. Particularly:

Composition 18a (comparative):

Dioctyl carbonate in acetone 0.68 mg/ml, corresponding to 16.88 mg/m². Composition 18b (comparative):

Dioctyl carbonate in acetone 0.30 mg/ml, corresponding to 7.50 mg/m².

### Composition 19 (Comparative):

Octadecanol in acetone 0.30 mg/ml, concentration chosen according to the amount of active ingredient used in the example to have a delivered dose of octadecanol in mg/m² equal to 1.5 times by weight in the case of Cypermethrin. Volume dispensed on 400 cm² tile: 1 ml corresponding to 7.50 mg/m².

Composition 20a (comparative):

Alcohol oleic 95.0% in acetone 28.53 mg/ml, concentration chosen according to the amount of active ingredient used in the example to have a delivered dose of alcohol oleic 95.0% in mg/m² equal to 4.8 times by weight in the case of Azamethiphos. Volume dispensed on 400 cm² tile: 1 ml corresponding to 713.23 mg/m².

Composition 20b (comparative):

Alcohol oleic 95.0% in acetone 1.90 mg/ml, concentration chosen according to the amount of active ingredient used in the example to have a delivered dose of alcohol oleic 95.0% in mg/m² equal to 5 times by weight in the case of Azamethiphos. Volume dispensed on 400 cm² tile: 1 ml corresponding to 47.55 mg/m².

Composition 20c (comparative):

Alcohol oleic 95.0% in acetone 78.76 mg/ml, concentration chosen according to the amount of active ingredient used in the example to have a delivered dose of alcohol oleic 95.0% in mg/m² equal to 5.3 times by weight in the case of Imidacloprid. Volume dispensed on 400 cm² tile: 1 ml corresponding to 1.97 g/m².

Composition 20d (comparative):

PBO in acetone 99.28 mg/ml, concentration chosen according to the amount of active ingredient used in the example to have a delivered dose of PBO in mg/m² equal to 6.5 times by weight in the case of Imidacloprid. Volume dispensed on 400 cm² tile: 1 ml corresponding to 2.48 g/m².

### Composition 21 (Comparative):

Dioctyl carbonate in acetone 84.08 mg/ml, concentration chosen according to the amount of active ingredient used in the example to have a delivered dose of dioctyl carbonate in mg/m² equal to 5.6 times by weight in the case of Imidacloprid. Volume dispensed on 400 cm² tile: 1 ml corresponding to 2.10 g/m².

### Composition 22 (Comparative):

Dioctyl carbonate in acetone. The concentration, between 0.14 and 0.94 mg/ml, is chosen according to the amount of active ingredient used in the example to have a delivered dose of dioctyl carbonate in mg/m² between 0.59 and 3.9 times by weight in the case of Spinosad. Volume dispensed on 400 cm² tile: 1 ml. Particularly:

Composition 22a (comparative):

Dioctyl carbonate in acetone 0.14 mg/ml, corresponding to 3.53 mg/m².

Composition 22b (comparative):

Dioctyl carbonate in acetone 0.47 mg/ml, corresponding to 11.75 mg/m².

Composition 22c (comparative):

Dioctyl carbonate in acetone 0.94 mg/ml, corresponding to 23.48 mg/m².

### Composition 23a (Comparative):

Azamethiphos in acetone 6.90 mg/ml. Volume dispensed on 400 cm² tile: 1 ml, Azamethiphos=172.50 mg/m².

Composition 23b (comparative):

Azamethiphos in acetone 0.46 mg/ml. Volume dispensed on 400 cm² tile: 1 ml, Azamethiphos=11.50 mg/m².

### Composition 24 (Comparative):

Imidacloprid in acetone 15.00 mg/ml. Volume dispensed on 400 cm² tile: 1 ml, Imidacloprid=375.00 mg/m².

Composition 25a (comparative):

Oleyl acetate in acetone 0.68 mg/ml, concentration chosen according to the amount of active ingredient used in the example to have a delivered dose of oleyl acetate in mg/m² equal to 1.5 times by weight in the case of Cypermethrin. Volume dispensed on 400 cm² tile: 1 ml, corresponding to 16.88 mg/m².

Composition 25b (comparative):

Oleyl acetate in acetone 0.30 mg/ml, concentration chosen according to the amount of active ingredient used in the example to have a delivered dose of oleyl acetate in mg/m² equal to 1.5 times by weight in the case of Cypermethrin. Volume dispensed on 400 cm² tile: 1 ml, corresponding to 7.50 mg/m².

Composition 26a (comparative):

Oleyl acetate in acetone 0.15 mg/ml, concentration chosen according to the amount of active ingredient used in the example to have a delivered dose of oleyl acetate in mg/m² equal to 0.64 times by weight in the case of Spinosad. Volume dispensed on 400 cm² tile: 1 ml, corresponding to 3.83 mg/m².

Composition 26b (comparative):

Oleyl acetate in acetone 0.51 mg/ml, concentration chosen according to the amount of active ingredient used in the example to have a delivered dose of oleyl acetate in mg/m² equal to 2.1 times by weight in the case of Spinosad. Volume dispensed on 400 cm² tile: 1 ml, corresponding to 12.73 mg/m².

Composition 26c (comparative):

Oleyl acetate in acetone 1.02 mg/ml, concentration chosen according to the amount of active ingredient used in the example to have a delivered dose of oleyl acetate in mg/m² equal to 4.2 times by weight in the case of Spinosad. Volume dispensed on 400 cm² tile: 1 ml, corresponding to 25.45 mg/m².

Composition 27a (comparative):

Oleyl acetate in acetone 33.00 mg/ml, concentration chosen according to the amount of active ingredient used in the example to have a delivered dose of oleyl acetate in mg/m² equal to 4.8 times by weight in the case of Azamethiphos. Volume dispensed on 400 cm² tile: 1 ml, corresponding to 824.90 mg/m².

Composition 27b (comparative):

Oleyl acetate in acetone 2.20 mg/ml, concentration chosen according to the amount of active ingredient used in the example to have a delivered dose of oleyl acetate in mg/m² equal to 5 times by weight in the case of Azamethiphos. Volume dispensed on 400 cm² tile: 1 ml, corresponding to 55.00 mg/m².

### Composition 28 (Comparative):

Oleyl acetate in acetone 91.09 mg/ml, concentration chosen according to the amount of active ingredient used in the example to have a delivered dose of oleyl acetate in mg/m² equal to 6.1 times by weight in the case of Imidacloprid. Volume dispensed on 400 cm² tile: 1 ml, corresponding to 2.28 g/m².

### Composition 29 (Comparative):

Dodecyl acetate in acetone 0.30 mg/ml, concentration chosen according to the amount of active ingredient used in the example to have a delivered dose of dodecyl acetate in mg/m² equal to 1.5 times by weight in the case of Cypermethrin. Volume dispensed on 400 cm² tile: 1 ml, corresponding to 7.50 mg/m².

### Composition 30 (Comparative):

n-Octyl acetate in acetone 0.30 mg/ml, concentration chosen according to the amount of active ingredient used in the example to have a delivered dose of n-Octyl acetate in mg/m² equal to 1.5 times by weight in the case of Cypermethrin. Volume dispensed on 400 cm² tile: 1 ml, corresponding to 7.50 mg/m².

Composition 31 (comparative) 1,2-hexandiol in acetone. The concentration, between 0.05 and 1.05 mg/ml, is chosen according to the amount of active ingredient used in the example to have a delivered dose of 1,2-hexandiol in mg/m² between 1.5 and 2.3 times by weight in the case of Cypermethrin. Volume dispensed on 400 cm² tile: 1 ml. Particularly:
Composition 31a (comparative):

1,2-hexandiol in acetone 0.68 mg/ml, corresponding to 16.88 mg/m².

Composition 31b (comparative):

1,2-hexandiol in acetone 1.05 mg/ml, corresponding to 26.13 mg/m².

Composition 31c (comparative):

1,2-hexandiol in acetone 0.05 mg/ml, corresponding to 1.20 mg/m².

Composition 31d (comparative):

1,2-hexandiol in acetone 0.07 mg/ml, corresponding to 1.85 mg/m².

### Composition 32 (Comparative):

1,2-hexandiol in acetone 12.56 mg/ml, concentration chosen according to the amount of active ingredient used in the example to have a delivered dose of 1,2-hexandiol in mg/m² equal to 1.8 times by weight in the case of Azamethiphos. Volume dispensed on 400 cm² tile: 1 ml, corresponding to 313.93 mg/m².

### Composition 33 (Comparative):

1,2-hexandiol in acetone 0.39 mg/ml, concentration chosen according to the amount of active ingredient used in the example to have a delivered dose of 1,2-hexandiol in mg/m² equal to 1.6 times by weight in the case of Spinosad. Volume dispensed on 400 cm² tile: 1 ml, corresponding to 9.68 mg/m².

### Composition 34 (Comparative):

1,2-hexandiol in acetone 2.34 mg/ml, concentration chosen according to the amount of active ingredient used in the example to have a delivered dose of 1,2-hexandiol in mg/m² equal to 3.3 times by weight in the case of Pyrethrins. Volume dispensed on 400 cm² tile: 1 ml, corresponding to 58.43 mg/m².

### Composition 35 (Comparative):

1,2-hexandiol in acetone 34.67 mg/ml, concentration chosen according to the amount of active ingredient used in the example to have a delivered dose of 1,2-hexandiol in mg/m² equal to 2.3 times by weight in the case of Imidacloprid. Volume dispensed on 400 cm² tile: 1 ml, corresponding to 866.65 mg/m².

### Composition 36 (Comparative):

Imidacloprid in acetone 0.20 mg/ml. Volume dispensed on 400 cm² tile: 1 ml, Imidacloprid=5.00 mg/m².

### Composition 37 (Comparative):

Oleic alcohol 95% in acetone 2.00 mg/ml. Volume dispensed on 400 cm² tile: 1 ml, Imidacloprid=50.00 mg/m².

Composition 38a (comparative):

1,2-octandiol in acetone 0.68 mg/ml, concentration chosen according to the amount of active ingredient used in the example to have a delivered dose of 1,2-octandiol in mg/m² equal to 1.5 times by weight in the case of Cypermethrin. Volume dispensed on 400 cm² tile: 1 ml, corresponding to 16.88 mg/m².

Composition 38b (comparative):

1,2-octandiol in acetone 0.30 mg/ml, concentration chosen according to the amount of active ingredient used in the example to have a delivered dose of 1,2-octandiol in mg/m² equal to 1.5 times by weight in the case of Cypermethrin. Volume dispensed on 400 cm² tile: 1 ml, corresponding to 7.50 mg/m².

### Composition 39 (Comparative):

1,8-octandiol in acetone 0.30 mg/ml, concentration chosen according to the amount of active ingredient used in the example to have a delivered dose of 1,8-octandiol in mg/m² equal to 1.5 times by weight in the case of Cypermethrin. Volume dispensed on 400 cm² tile: 1 ml, corresponding to 7.50 mg/m².

Composition 40a (comparative):

1,8-octandiol in acetone 0.68 mg/ml, concentration chosen according to the amount of active ingredient used in the example to have a delivered dose of 1,8-octandiol in mg/m² equal to 2.9 times by weight in the case of Imidacloprid. Volume dispensed on 400 cm² tile: 1 ml, corresponding to 16.88 mg/m².

Composition 40b (comparative):

1,8-octandiol in acetone 42.90 mg/ml, concentration chosen according to the amount of active ingredient used in the example to have a delivered dose of 1,8-octandiol in mg/m² equal to 2.9 times by weight in the case of Imidacloprid. Volume dispensed on 400 cm² tile: 1 ml, corresponding to 1.07 g/m².

Composition 41a (comparative):

1,2-dodecandiol in acetone 0.68 mg/ml, concentration chosen according to the amount of active ingredient used in the example to have a delivered dose of 1,2-dodecandiol in mg/m² equal to 1.5 times by weight in the case of Cypermethrin. Volume dispensed on 400 cm² tile: 1 ml, corresponding to 16.88 mg/m².

Composition 41b (comparative):

1,2-dodecandiol in acetone 0.30 mg/ml, concentration chosen according to the amount of active ingredient used in the example to have a delivered dose of 1,2-dodecandiol in mg/m² equal to 1.5 times by weight in the case of Cypermethrin. Volume dispensed on 400 cm² tile: 1 ml, corresponding to 7.50 mg/m².

### Composition 42 (Comparative):

1,2-dodecandiol in acetone 59.36 mg/ml, concentration chosen according to the amount of active ingredient used in the example to have a delivered dose of 1,2-dodecandiol in mg/m² equal to 4.0 times by weight in the case of Imidacloprid. Volume dispensed on 400 cm² tile: 1 ml, corresponding to 1.48 g/m².

### Composition 43 (Comparative):

Spinosad in acetone 0.24 mg/ml. Volume dispensed on 400 cm² tile: 1 ml, Spinosad=6.00 mg/m².

Composition 44a (comparative):

Dioctyl carbonate in acetone 30.44 mg/ml, concentration chosen according to the amount of active ingredient used in the example to have a delivered dose of dioctyl carbonate in mg/m² equal to 4.4 times by weight in the case of Azamethiphos. Volume dispensed on 400 cm² tile: 1 ml, corresponding to 760.98 mg/m².

Composition 44b (comparative):

Dioctyl carbonate in acetone 2.03 mg/ml, concentration chosen according to the amount of active ingredient used in the example to have a delivered dose of dioctyl carbonate in mg/m² equal to 4.4 times by weight in the case of Azamethiphos. Volume dispensed on 400 cm² tile: 1 ml, corresponding to 50.73 mg/m².

### Composition 45 (Comparative):

1,12-dodecandiol in acetone 0.30 mg/ml, concentration chosen according to the amount of active ingredient used in the example to have a delivered dose of 1,12-dodecandiol in mg/m² equal to 1.5 times by weight in the case of Cypermethrin. Volume dispensed on 400 cm² tile: 1 ml, corresponding to 7.50 mg/m².

Composition 46a (comparative):

Cypermethrin in acetone 0.23 mg/ml. Volume dispensed on 400 cm² tile: 1 ml, Cypermethrin=5.75 mg/m².

Composition 46b (comparative):
Cypermethrin in acetone 0.10 mg/ml. Volume dispensed on 400 cm² tile: 1 ml, Cypermethrin=5.00 mg/m².

Here below are reported 36 independent experiments performed using the above indicated compositions.

At the end of the experimental section, Tables 37, 38 summarise the obtained data, to better highlight the surprising results obtained when using composition according to the present invention.

### Example 1: Activity on Musca domestica L

Method: Contact test on non-porous tile measuring 400 cm² at a temperature of 28° C. Test duration: up to 48 hours after exposure of the insect to the insecticidal active substance.

Flies used for testing: 10.

Three tests were performed in parallel, A, B, and C, as follows:
A) Comparative. 1 ml of Composition 1 was applied to the tile. After waiting for the complete evaporation of the solvent, 10 flies were placed on top of the treated tile, starting the test.
B) According to the invention. 1 ml of Composition 8a was distributed on the tile. After waiting for the complete evaporation of the solvent, 1 ml of Composition 1 was added to the same tile. Subsequently, after waiting for the solvent to evaporate, 10 flies were placed on top of the treated tile, starting the test.
C) According to the invention. 1 ml of Composition 8a was distributed on a tile. After waiting for the complete evaporation of the solvent, 10 flies were placed for 30 minutes on top of the treated tile. At the end of the 30 minutes, the flies were transferred to an untreated area. After waiting 3 hours, the tile was treated with 1 ml of Composition 1, and, after evaporation of the solvent, the flies that had previously come into contact with said Composition 8a were repositioned on the tile, starting the test.

Each experiment (A-C) was conducted in triplicate.

A control test was carried out in parallel by placing the flies on an untreated tile.

TABLE 1

| (A) | (B) | (C) | Control | |
|---|---|---|---|---|
| Mortality | Mortality | Mortality | Mortality | Time |
| % | % | % | % | (h) |
| 70 | 94 | 87 | 0 | 24 |
| 73 | 94 | 90 | 0 | 48 |

The results, shown in Table 1, show a clear synergistic effect obtained in both conditions

B and C on Musca domestica L.

### Example 2: Activities on Blatta orientalis

Method: Contact test on non-porous tile measuring 400 cm² at a temperature of 28° C. Test duration: up to 72 hours after exposure of the insect to the insecticidal active substance.

Cockroaches used for tests: 10.

Three tests were performed in parallel, A, B, and C, as follows:
A) Comparative. 1 ml of Composition 2 was applied to the tile. After waiting for the complete evaporation of the solvent, 10 cockroaches were placed on top of the treated tile, starting the test.
B) According to the invention. 1 ml of Composition 8b was distributed on the tile. After waiting for the complete evaporation of the solvent, 1 ml of Composition 2 was added to the same tile. Subsequently, after waiting for the solvent to evaporate, 10 cockroaches were placed on top of the treated tile, starting the test.
C) According to the invention. 1 ml of Composition 8b was distributed on a tile. After waiting for the complete evaporation of the solvent, 10 cockroaches were placed for 30 minutes on top of the treated tile. At the end of the 30 minutes, the cockroaches were transferred to an untreated area. After waiting 3 hours, the tile was treated with 1 ml of Composition 2, and, after evaporation of the solvent, the cockroaches that had previously come into contact with said Composition 8b were repositioned on the tile, starting the test.

Each experiment (A-C) was conducted in triplicate.

A control test was carried out in parallel by placing cockroaches on an untreated tile.

TABLE 2

| (A) | (B) | (C) | Control | |
|---|---|---|---|---|
| Mortality | Mortality | Mortality | Mortality | Time |
| % | % | % | % | (h) |
| 0 | 17 | 28 | 0 | 24 |
| 7 | 23 | 44 | 0 | 48 |
| 7 | 33 | 44 | 0 | 72 |

The results show a clear synergistic effect obtained with alcohol and Pyrethrins on Blatta orientalis.

### Example 3: Activity on Musca domestica L

Method: Contact test on non-porous tile measuring 400 cm² at a temperature of 26° C. Test duration: up to 48 hours after exposure of the insect to the insecticidal active substance.

Flies used for testing: 10.

Three tests were performed in parallel, A, B, and C, as follows:
A) Comparative. 1 ml of Composition 3 was applied to the tile. After waiting for the complete evaporation of the solvent, 10 flies were placed on top of the treated tile, starting the test.
B) According to the invention. 1 ml of Composition 8c was distributed on the tile. After waiting for the complete evaporation of the solvent, 1 ml of Composition 3 was added to the same tile. Subsequently, after waiting for the solvent to evaporate, 10 flies were placed on top of the treated tile, starting the test.
C) According to the invention. 1 ml of Composition 8c was distributed on a tile. After waiting for the complete evaporation of the solvent, 10 flies were placed for 30 minutes on top of the treated tile. At the end of the 30 minutes, the flies were transferred to an untreated area. After waiting 3 hours, a new tile was treated with 1 ml of Composition 3 and, after evaporation of the solvent, the flies that had previously come into contact with said Composition 8c were repositioned on the tile, starting the test.

Each experiment (A-C) was conducted in triplicate.

A control test was carried out in parallel by placing the flies on an untreated tile.

TABLE 3

| (A) | (B) | (C) | Control | |
|---|---|---|---|---|
| Mortality | Mortality | Mortality | Mortality | Time |
| % | % | % | % | (h) |
| 10 | 40 | 70 | 0 | 24 |
| 20 | 40 | 70 | 0 | 48 |

The results show a clear synergistic effect obtained with alcohol and Cypermethrin on Musca domestica L.

### Example 4: Activities on Blatta orientalis

Method: Contact test on non-porous tile measuring 400 cm² at a temperature of 28° C. Test duration: up to 120 hours after exposure of the insect to the insecticidal active substance.

Cockroaches used for tests: 10.

Three tests were performed in parallel, A, B, and C, as follows:
A) Comparative. 1 ml of Composition 4a was applied to the tile. After waiting for the complete evaporation of the solvent, 10 cockroaches were placed on top of the treated tile, starting the test.
B) According to the invention. 1 ml of Composition 8d was distributed on the tile. After waiting for the complete evaporation of the solvent, 1 ml of Composition 4a was added to the same tile. After waiting for the solvent to evaporate, 10 cockroaches were placed on top of the treated tile, starting the test.
C) According to the invention. 1 ml of Composition 8d was distributed on a tile. After waiting for the complete evaporation of the solvent, 10 cockroaches were placed for 30 minutes on top of the treated tile. At the end of the 30 minutes, the cockroaches were transferred to an untreated area. After waiting 3 hours, a new tile was treated with 1 ml of Composition 4a and, after evaporation of the solvent, the cockroaches that had previously come into contact with said Composition 8d were repositioned on the tile, starting the test.

Each experiment (A-C) was conducted in triplicate.

A control test was carried out in parallel by placing cockroaches on an untreated tile.

TABLE 4

| (A) | (B) | (C) | Control | |
|---|---|---|---|---|
| Mortality | Mortality | Mortality | Mortality | Time |
| % | % | % | % | (h) |
| 30 | 90 | 90 | 0 | 24 |
| 35 | 95 | 100 | 0 | 48 |
| 35 | 95 | 100 | 0 | 120 |

The results show a clear synergistic effect obtained with alcohol and Cypermethrin on Blatta orientalis.

### Example 5: Activity on Musca domestica L

Method: Contact test on non-porous tile measuring 400 cm² at a temperature of 28° C. Test duration: up to 48 hours after exposure of the insect to the insecticidal active substance.

Flies used for testing: 10.

Six tests were performed in parallel, A, B, C, D, E and F, as follows:
A) Comparative. 1 ml of Composition 9a was distributed on the tile. After waiting for the complete evaporation of the solvent, 1 ml of Composition 3 was added to the same tile. Subsequently, after waiting for the solvent to evaporate, 10 flies were placed on top of the treated tile, starting the test.
B) Comparative. 1 ml of Composition 9a was distributed on a tile. After waiting for the complete evaporation of the solvent, 10 flies were placed for 30 minutes on top of the treated tile. At the end of the 30 minutes, the flies were transferred to an untreated area. After waiting 3 hours, a tile was treated with 1 ml of Composition 3 and, after evaporation of the solvent, the flies that had previously come into contact with said Composition 9a were repositioned on the tile, starting the test.
C) Comparative. 1 ml of Composition 10a was distributed on the tile. After waiting for the complete evaporation of the solvent, 1 ml of Composition 3 was added to the same tile. Subsequently, after waiting for the solvent to evaporate, 10 flies were placed on top of the treated tile, starting the test.
D) Comparative. 1 ml of Composition 10a was distributed on a tile. After waiting for the complete evaporation of the solvent, 10 flies were placed for 30 minutes on top of the treated tile. At the end of the 30 minutes, the flies were transferred to an untreated area. After waiting 3 hours, a tile was treated with 1 ml of Composition 3 and, after evaporation of the solvent, the flies that had previously come into contact with said Composition 10a were repositioned on the tile, starting the test.
E) According to the invention. 1 ml of Composition 8c was distributed on the tile. After waiting for the complete evaporation of the solvent, 1 ml of Composition 3 was added to the same tile. Subsequently, after waiting for the solvent to evaporate, 10 flies were placed on top of the treated tile, starting the test.
F) According to the invention. 1 ml of Composition 8c was distributed on a tile. After waiting for the complete evaporation of the solvent, 10 flies were placed for 30 minutes on top of the treated tile. At the end of the 30 minutes, the flies were transferred to an untreated area. After waiting 3 hours, a new tile was treated with 1 ml of Composition 3 and, after evaporation of the solvent, the flies that had previously come into contact with said Composition 8c were repositioned on the tile, starting the test.

Each experiment (A-F) was conducted in triplicate.

A control test was carried out in parallel by placing the flies on an untreated tile.

TABLE 5

| (A) | (B) | (C) | (D) | (E) | (F) | Control | |
|---|---|---|---|---|---|---|---|
| Mortality | Mortality | Mortality | Mortality | Mortality | Mortality | Mortality | Time |
| % | % | % | % | % | % | % | (h) |
| 40 | 80 | 20 | 40 | 40 | 70 | 0 | 24 |
| 40 | 80 | 20 | 50 | 40 | 70 | 0 | 48 |

The synergy between oleic and active alcohol (E, F), according to the invention, is comparable to that shown by PBO (A, B) and decidedly higher than that shown by fatty acids (C, D) on Musca domestica L.

### Example 6: Activities on Blatta orientalis

Method: Contact test on non-porous tile measuring 400 cm² at a temperature of 28° C. Test duration: up to 120 hours after exposure of the insect to the insecticidal active substance.

Cockroaches used for tests: 10.

Six tests were performed in parallel, A, B, C, D, E and F, as follows:
A) Comparative. 1 ml of Composition 9b was distributed on the tile. After waiting for the complete evaporation of the solvent, 1 ml of Composition 4a was added to the same tile. Subsequently, after waiting for the solvent to evaporate, 10 cockroaches were placed on top of the treated tile, starting the test.
B) Comparative. 1 ml of Composition 9b was distributed on a tile. After waiting for the complete evaporation of the solvent, 10 cockroaches were placed for 30 minutes on top of the treated tile. At the end of the 30 minutes, the cockroaches were transferred to an untreated area. After waiting 3 hours, a new tile was treated with 1 ml of Composition 4a, and, after evaporation of the solvent, the cockroaches that had previously come into contact with said Composition 9b were repositioned on the tile, starting the test.
C) Comparative. 1 ml of Composition 10b was distributed on the tile. After waiting for the complete evaporation of the solvent, 1 ml of Composition 4a was added to the same tile. Subsequently, after waiting for the solvent to evaporate, 10 cockroaches were placed on top of the treated tile, starting the test.
D) Comparative. 1 ml of Composition 10b was distributed on a tile. After waiting for the complete evaporation of the solvent, 10 cockroaches were placed for 30 minutes on top of the treated tile. At the end of the 30 minutes, the cockroaches were transferred to an untreated area. After waiting 3 hours, a new tile was treated with 1 ml of Composition 4a and, after evaporation of the solvent, the cockroaches that had previously come into contact with said Composition 10b were repositioned on the tile, starting the test.
E) According to the invention. 1 ml of Composition 8d was distributed on the tile. After waiting for the complete evaporation of the solvent, 1 ml of Composition 4a was added to the same tile. Subsequently, after waiting for the solvent to evaporate, 10 cockroaches were placed on top of the treated tile, starting the test.
F) According to the invention. 1 ml of Composition 8d was distributed on a tile. After waiting for the complete evaporation of the solvent, 10 cockroaches were placed for 30 minutes on top of the treated tile. At the end of the 30 minutes, the cockroaches were transferred to an untreated area. After waiting 3 hours, a new tile was treated with 1 ml of Composition 4a and, after evaporation of the solvent, the cockroaches that had previously come into contact with said Composition 8d were repositioned on the tile, starting the test.

Each experiment (A-F) was conducted in triplicate.

A control test was carried out in parallel by placing cockroaches on an untreated tile.

TABLE 6

| (A) | (B) | (C) | (D) | (E) | (F) | Control | |
|---|---|---|---|---|---|---|---|
| Mortality | Mortality | Mortality | Mortality | Mortality | Mortality | Mortality | Time |
| % | % | % | % | % | % | % | (h) |
| 80 | 80 | 80 | 70 | 90 | 90 | 0 | 24 |
| 85 | 85 | 80 | 75 | 95 | 100 | 0 | 48 |
| 90 | 85 | 85 | 90 | 95 | 100 | 0 | 120 |

The synergy shown by the combination according to the present invention (E, F) is superior to that observed in the remaining samples on Blatta orientalis.

### Example 7: Activity on Musca domestica L

Method: Contact test on non-porous tile measuring 400 cm² at a temperature of 20° C. Test duration: up to 48 hours after exposure of the insect to the insecticidal active substance.

Flies used for testing: 10.

Three tests were performed in parallel, A, B and C, as follows:
A) According to the invention. 1 ml of Composition 5a, was distributed on the tile. After waiting for the complete evaporation of the solvent, 10 flies were placed on top of the treated tile, starting the test.
B) Comparative. 1 ml of Composition 6a was distributed on the tile. After waiting for the complete evaporation of the solvent, 10 flies were placed on top of the treated tile, starting the test.
C) Comparative. 1 ml of Composition 7a was distributed on the tile. After waiting for the complete evaporation of the solvent, 10 flies were placed on top of the treated tile, starting the test.

Each experiment (A-C) was conducted in triplicate.

A control test was carried out in parallel by placing the flies on an untreated tile.

TABLE 7

| (A) | (B) | (C) | Control | |
|---|---|---|---|---|
| Mortality | Mortality | Mortality | Mortality | Time |
| % | % | % | % | (h) |
| 80 | 65 | 60 | 0 | 24 |
| 87 | 65 | 69 | 0 | 48 |

For flies, mortality is much higher using composition (A), according to the invention, on

Musca domestica L.

### Example 8: Activities on Blatta orientalis

Method: Contact test on non-porous tile measuring 400 cm² at a temperature of 20° C. Test duration: up to 48 hours after exposure of the insect to the insecticidal active substance.

Cockroaches used for tests: 10.

Three tests were performed in parallel, A, B and C, as follows:
A) According to the invention. 1 ml of Composition 5b was distributed on the tile. After waiting for the complete evaporation of the solvent, 10 cockroaches were placed on top of the treated tile, starting the test.
B) Comparative. 1 ml of Composition 6b was distributed on the tile. After waiting for the complete evaporation of the solvent, 10 cockroaches were placed on top of the treated tile, starting the test.
C) Comparative. 1 ml of Composition 7b was distributed on the tile. After waiting for the complete evaporation of the solvent, 10 cockroaches were placed on top of the treated tile, starting the test.

Each experiment (A-C) was conducted in triplicate.

A control test was carried out in parallel by placing cockroaches on an untreated tile.

TABLE 8

| (A) | (B) | (C) | Control | |
|---|---|---|---|---|
| Mortality | Mortality | Mortality | Mortality | Time |
| % | % | % | % | (h) |
| 50 | 50 | 50 | 0 | 24 |
| 63 | 50 | 57 | 0 | 48 |

The formulation (A) according to the present invention is slightly more effective on Blatta orientalis.

### Example 9: Activity on Musca domestica L

Method: Contact test on non-porous tile measuring 400 cm² at a temperature of 21° C. Test duration: up to 48 hours after exposure of the insect to the insecticidal active substance.

Flies used for testing: 10.

Four tests were performed in parallel, A, B, C and D, as follows:
A) Comparative. 1 ml of Composition 3 was distributed on the tile. After waiting for the complete evaporation of the solvent, 10 flies were placed on top of the treated tile, starting the test.
B) Comparative. 1 ml of Composition 9a was distributed on the tile. After waiting for the complete evaporation of the solvent, 1 ml of Composition 3 was added to the same tile. Subsequently, after waiting for the solvent to evaporate, 10 flies were placed on top of the treated tile, starting the test.
C) According to the invention. 1 ml of Composition 11a was distributed on a tile. After waiting for the complete evaporation of the solvent, 1 ml of Composition 3 was added to the same tile. Subsequently, after waiting for the solvent to evaporate, 10 flies were placed on top of the treated tile, starting the test.
D) According to the invention. 1 ml of Composition 12a was distributed on a tile. After waiting for the complete evaporation of the solvent, 1 ml of Composition 3 was added to the same tile. Subsequently, after waiting for the solvent to evaporate, 10 flies were placed on top of the treated tile, starting the test.

Each experiment (A-D) was conducted in duplicate.

A control test was carried out in parallel by placing the flies on an untreated tile.

TABLE 9

| (A) | (B) | (C) | (D) | Control | |
|---|---|---|---|---|---|
| Mortality | Mortality | Mortality | Mortality | Mortality | Time |
| % | % | % | % | % | (h) |
| 5 | 68 | 50 | 25 | 0 | 24 |
| 16 | 70 | 60 | 60 | 0 | 48 |

Oleic alcohol 95% (C) and 2-octyldodecanol (D) both show a synergistic effect, comparable to the activity shown by PBO (B) on Musca domestica L.

### Example 10: Activities on Blatta orientalis

Method: Contact test on non-porous tile measuring 400 cm² at a temperature of 21° C. Test duration: up to 48 hours after exposure of the insect to the insecticidal active substance.

Cockroaches used for tests: 10.

Four tests were performed in parallel, A, B, C and D, as follows:
A) Comparative. 1 ml of Composition 4a was distributed on the tile. After waiting for the complete evaporation of the solvent, 10 cockroaches were placed on top of the treated tile, starting the test.
B) Comparative. 1 ml of Composition 9b was distributed on the tile. After waiting for the complete evaporation of the solvent, 1 ml of Composition 4a was added to the same tile. Subsequently, after waiting for the solvent to evaporate, 10 cockroaches were placed on top of the treated tile, starting the test.
C) According to the invention. 1 ml of Composition 11b was distributed on a tile. After waiting for the complete evaporation of the solvent, 1 ml of Composition 4a was added to the same tile. Subsequently, after waiting for the solvent to evaporate, 10 cockroaches were placed on top of the treated tile, starting the test.
D) According to the invention. 1 ml of Composition 12b was distributed on a tile. After waiting for the complete evaporation of the solvent, 1 ml of Composition 4a was added to the same tile. Subsequently, after waiting for the solvent to evaporate, 10 cockroaches were placed on top of the treated tile, starting the test. Each experiment (A-D) was conducted in duplicate.

A control test was carried out in parallel by placing cockroaches on an untreated tile.

TABLE 10

| (A) | (B) | (C) | (D) | Control | |
|---|---|---|---|---|---|
| Mortality | Mortality | Mortality | Mortality | Mortality | Time |
| % | % | % | % | % | (h) |
| 20 | 70 | 70 | 75 | 0 | 24 |
| 35 | 70 | 85 | 90 | 0 | 48 |

The synergy shown between oleic alcohol 95% (C) or 2-octyldodecanol (D) and Cypermethrin, according to the invention, is superior to that shown with PBO (B) on Blatta orientalis.

### Example 11: Activities on Blatta orientalis

Method: Contact test on non-porous tile measuring 400 cm² at a temperature of 21° C. Test duration: up to 96 hours after exposure of the insect to the insecticidal active substance.

Cockroaches used for tests: 10.

Six tests were performed in parallel, A, B, C, D, E and F, as follows:
A) According to the invention. 1 ml of Composition 13 was distributed on the tile. After waiting for the complete evaporation of the solvent, 1 ml of Composition 4a was added to the same tile. Subsequently, after waiting for the solvent to evaporate, 10 cockroaches were placed on top of the treated tile, starting the test.
B) According to the invention. 1 ml of Composition 14 was distributed on a tile. After waiting for the complete evaporation of the solvent, 1 ml of Composition 4a was added to the same tile. Subsequently, after waiting for the solvent to evaporate, 10 cockroaches were placed on top of the treated tile, starting the test.
C) According to the invention. 1 ml of Composition 15 was distributed on a tile. After waiting for the complete evaporation of the solvent, 1 ml of Composition 4a was added to the same tile. Subsequently, after waiting for the solvent to evaporate, 10 cockroaches were placed on top of the treated tile, starting the test.
D) According to the invention. 1 ml of Composition 16 was distributed on a tile. After waiting for the complete evaporation of the solvent, 1 ml of Composition 4a was added to the same tile. Subsequently, after waiting for the solvent to evaporate, 10 cockroaches were placed on top of the treated tile, starting the test.
E) According to the invention. 1 ml of Composition 19 was distributed on a tile. After waiting for the complete evaporation of the solvent, 1 ml of Composition 4a was added to the same tile. Subsequently, after waiting for the solvent to evaporate, 10 cockroaches were placed on top of the treated tile, starting the test.
F) Comparative. 1 ml of Composition 4a was distributed on the tile. After waiting for the complete evaporation of the solvent, 10 cockroaches were placed on top of the treated tile, starting the test.

Each experiment (A-F) was conducted in duplicate.

A control test was carried out in parallel by placing cockroaches on an untreated tile.

TABLE 11

| (A) | (B) | (C) | (D) | (E) | (F) | Control | |
|---|---|---|---|---|---|---|---|
| Mortality | Mortality | Mortality | Mortality | Mortality | Mortality | Mortality | Time |
| % | % | % | % | % | % | % | (h) |
| 60 | 50 | 50 | 40 | 65 | 20 | 0 | 48 |
| 100 | 75 | 85 | 80 | 80 | 25 | 0 | 72 |
| 100 | 80 | 100 | 95 | n.d. | 33 | 0 | 96 |

n.d = not determined.

The saturated alcohols examined have a synergizing effect on Cypermethrin on Blatta orientalis.

### Example 12: Activity on Musca domestica L

Method: Contact test on non-porous tile measuring 400 cm² at a temperature of 21° C. Test duration: up to 48 hours after exposure of the insect to the insecticidal active substance.

Flies used for testing: 10.

Three tests were performed in parallel, A, B and C, as follows:
A) Comparative. 1 ml of Composition 3 was distributed on the tile. After waiting for the complete evaporation of the solvent, 10 flies were placed on top of the treated tile, starting the test.
B) According to the invention. 1 ml of Composition 17a was distributed on a tile. After waiting for the complete evaporation of the solvent, 1 ml of Composition 3 was added to the same tile. Subsequently, after waiting for the solvent to evaporate, 10 flies were placed on top of the treated tile, starting the test.
C) According to the invention. 1 ml of Composition 18a was distributed on a tile. After waiting for the complete evaporation of the solvent, 1 ml of Composition 3 was added to the same tile. Subsequently, after waiting for the solvent to evaporate, 10 flies were placed on top of the treated tile, starting the test. Each experiment (A-C) was conducted in duplicate.

A control test was carried out in parallel by placing the flies on an untreated tile.

TABLE 12

| (A) | (B) | (C) | Control | |
|---|---|---|---|---|
| Mortality | Mortality | Mortality | Mortality | Time |
| % | % | % | % | (h) |
| 5 | 79 | 74 | 0 | 24 |
| 16 | 90 | 90 | 0 | 48 |

The bis(2-ethylhexyl)-carbonate (B) and dioctyl carbonate (C) compounds, applied with the active ingredient according to the method of invention, appear to have a high synergizing effect on Cypermethrin on Musca domestica L.

### Example 13: Activities on Blatta orientalis

Method: Contact test on non-porous tile measuring 400 cm² at a temperature of 21° C. Test duration: up to 72 hours after exposure of the insect to the insecticidal active substance.

Cockroaches used for tests: 10.

Three tests were performed in parallel, A, B and C, as follows:
A) According to the invention. 1 ml of Composition 17b was distributed on a tile. After waiting for the complete evaporation of the solvent, 1 ml of Composition 4a was added to the same tile. Subsequently, after waiting for the solvent to evaporate, 10 cockroaches were placed on top of the treated tile, starting the test.
B) According to the invention. 1 ml of Composition 18b was distributed on a tile. After waiting for the complete evaporation of the solvent, 1 ml of Composition 4a was added to the same tile. Subsequently, after waiting for the solvent to evaporate, 10 cockroaches were placed on top of the treated tile, starting the test.
C) Comparative. 1 ml of Composition 4a was distributed on the tile. After waiting for the complete evaporation of the solvent, 10 cockroaches were placed on top of the treated tile, starting the test.

Each experiment (A-C) was conducted in duplicate.

A control test was carried out in parallel by placing cockroaches on an untreated tile.

TABLE 13

| (A) | (B) | (C) | Control | |
|---|---|---|---|---|
| Mortality | Mortality | Mortality | Mortality | Time |
| % | % | % | % | (h) |
| 50 | 50 | 60 | 0 | 48 |
| 90 | 100 | 62 | 0 | 72 |

The bis(2-ethylhexyl)-carbonate (A) and dioctyl carbonate (B) compounds, applied with the active ingredient according to the method of invention, appear to have a synergizing effect on Cypermethrin on Blatta orientalis.

### Example 14: Activity on Musca domestica L

Method: Contact test on non-porous tile measuring 400 cm² at a temperature of 21° C. Test duration: up to 48 hours after exposure of the insect to the insecticidal active substance.

Flies used for testing: 10.

Two tests were performed in parallel, A and B, as follows:
A) Comparative. 1 ml of Composition 23a was distributed on the tile. After waiting for the complete evaporation of the solvent, 10 flies were placed on top of the treated tile, starting the test.
B) According to the invention. 1 ml of Composition 20a was distributed on a tile. After waiting for the complete evaporation of the solvent, 1 ml of Composition 23a was added to the same tile. Subsequently, after waiting for the solvent to evaporate, 10 flies were placed on top of the treated tile, starting the test. Each experiment (A-B) was conducted in duplicate.

A control test was carried out in parallel by placing the flies on an untreated tile.

TABLE 14

| (A) | (B) | Control | |
|---|---|---|---|
| Mortality | Mortality | Mortality | Time |
| % | % | % | (h) |
| 23 | 100 | 0 | 48 |

Oleic alcohol 95%, applied with the active ingredient according to the method of invention, appears to have a high synergizing effect on Azamethiphos on Musca domestica L.

### Example 15: Activities on Blatta orientalis

Method: Contact test on non-porous tile measuring 400 cm² at a temperature of 21° C. Test duration: up to 72 hours after exposure of the insect to the insecticidal active substance.

Cockroaches used for tests: 10.

Two tests were performed in parallel, A and B, as follows:
A) Comparative. 1 ml of Composition 23b was distributed on the tile. After waiting for the complete evaporation of the solvent, 10 cockroaches were placed on top of the treated tile, starting the test.
B) According to the invention. 1 ml of Composition 20b was distributed on a tile. After waiting for the complete evaporation of the solvent, 1 ml of Composition 23b was added to the same tile. Subsequently, after waiting for the solvent to evaporate, 10 cockroaches were placed on top of the treated tile, starting the test.

Each experiment (A-B) was conducted in duplicate.

A control test was carried out in parallel by placing cockroaches on an untreated tile.

TABLE 15

| (A) | (B) | Control | |
|---|---|---|---|
| Mortality | Mortality | Mortality | Time |
| % | % | % | (h) |
| 10 | 43 | 0 | 24 |
| 17 | 50 | 0 | 48 |
| 23 | 53 | 0 | 72 |

Oleic alcohol 95%, applied with the active ingredient according to the method of invention, appears to have a fine synergizing effect on Azamethiphos on Blatta orientalis.

### Example 16: Activities on Blatta lateralis

Method: Contact test on non-porous tile measuring 400 cm² at a temperature of 25° C.

Test duration: up to 48 hours after exposure of the insect to the insecticidal active substance.

Cockroaches used for tests: 10.

Three tests were performed in parallel, A, B and C, as follows:
A) Comparative. 1 ml of Composition 24 was distributed on the tile. After waiting for the complete evaporation of the solvent, 10 cockroaches were placed on top of the treated tile, starting the test.
B) According to the invention. 1 ml of Composition 20c was distributed on a tile. After waiting for the complete evaporation of the solvent, 1 ml of Composition 24 was added to the same tile. Subsequently, after waiting for the solvent to evaporate, 10 cockroaches were placed on top of the treated tile, starting the test.
C) According to the invention. 1 ml of Composition 20d was distributed on a tile. After waiting for the complete evaporation of the solvent, 1 ml of Composition 24 was added to the same tile. Subsequently, after waiting for the solvent to evaporate, 10 cockroaches were placed on top of the treated tile, starting the test.

Each experiment (A-C) was conducted in duplicate.

A control test was carried out in parallel by placing cockroaches on an untreated tile.

TABLE 16

| (A) | (B) | (C) | Control | |
|---|---|---|---|---|
| Mortality | Mortality | Mortality | Mortality | Time |
| % | % | % | % | (h) |
| 20 | 100 | 100 | 0 | 48 |

Oleic alcohol 95% (B), applied with the active ingredient according to the method of invention, has the same synergizing effect of PBO (C) that however is used in higher weight ratio with Imidacloprid on Blatta lateralis.

### Example 17: Activity on Musca domestica L

Method: Contact test on non-porous tile measuring 400 cm² at a temperature of 21° C. Test duration: up to 48 hours after exposure of the insect to the insecticidal active substance.

Flies used for testing: 10.

Two tests were performed in parallel, A and B, as follows:
A) Comparative. 1 ml of Composition 3 was distributed on the tile. After waiting for the complete evaporation of the solvent, 10 flies were placed on top of the treated tile, starting the test.
B) According to the invention. 1 ml of Composition 25a was distributed on a tile. After waiting for the complete evaporation of the solvent, 1 ml of Composition 3 was added to the same tile. Subsequently, after waiting for the solvent to evaporate, 10 flies were placed on top of the treated tile, starting the test. Each experiment (A-B) was conducted in duplicate.

A control test was carried out in parallel by placing the flies on an untreated tile.

TABLE 17

| (A) | (B) | Control | |
|---|---|---|---|
| Mortality | Mortality | Mortality | Time |
| % | % | % | (h) |
| 16 | 89 | 0 | 48 |

Oleyl acetate, applied with the active ingredient according to the method of invention, appears to have a high synergizing effect on Cypermethrin on Musca domestica L.

### Example 18: Activity on Musca domestica L

Method: Contact test on non-porous tile measuring 400 cm² at a temperature of 21° C. Test duration: up to 24 hours after exposure of the insect to the insecticidal active substance.

Flies used for testing: 10.

Two tests were performed in parallel, A and B, as follows:
A) Comparative. 1 ml of Composition 23a was distributed on the tile. After waiting for the complete evaporation of the solvent, 10 flies were placed on top of the treated tile, starting the test.
B) According to the invention. 1 ml of Composition 27a was distributed on a tile. After waiting for the complete evaporation of the solvent, 1 ml of Composition 23a was added to the same tile. Subsequently, after waiting for the solvent to evaporate, 10 flies were placed on top of the treated tile, starting the test. Each experiment (A-B) was conducted in duplicate.

A control test was carried out in parallel by placing the flies on an untreated tile.

TABLE 18

| (A) | (B) | Control | |
|---|---|---|---|
| Mortality | Mortality | Mortality | Time |
| % | % | % | (h) |
| 23 | 100 | 0 | 24 |

Oleyl acetate, applied with the active ingredient according to the method of invention, appears to have a high synergizing effect on Azamethiphos on Musca domestica L.

### Example 19: Activity on Musca domestica L

Method: Contact test on non-porous tile measuring 400 cm² at a temperature of 25° C. Test duration: up to 48 hours after exposure of the insect to the insecticidal active substance.

Flies used for testing: 10.

Four tests were performed in parallel, A, B, C and D, as follows:
A) Comparative. 1 ml of Composition 43 was distributed on the tile. After waiting for the complete evaporation of the solvent, 10 flies were placed on top of the treated tile, starting the test.
B) According to the invention. 1 ml of Composition 26a was distributed on a tile. After waiting for the complete evaporation of the solvent, 1 ml of Composition 43 was added to the same tile. Subsequently, after waiting for the solvent to evaporate, 10 flies were placed on top of the treated tile, starting the test.
C) According to the invention. 1 ml of Composition 26b was distributed on a tile. After waiting for the complete evaporation of the solvent, 1 ml of Composition 43 was added to the same tile. Subsequently, after waiting for the solvent to evaporate, 10 flies were placed on top of the treated tile, starting the test.
D) According to the invention. 1 ml of Composition 26c was distributed on a tile. After waiting for the complete evaporation of the solvent, 1 ml of Composition 43 was added to the same tile. Subsequently, after waiting for the solvent to evaporate, 10 flies were placed on top of the treated tile, starting the test.

Each experiment (A-D) was conducted in duplicate.

A control test was carried out in parallel by placing the flies on an untreated tile.

TABLE 19

| (A) | (B) | (C) | (D) | Control | |
|---|---|---|---|---|---|
| Mortality | Mortality | Mortality | Mortality | Mortality | Time |
| % | % | % | % | % | (h) |
| 27 | 51 | 38 | 48 | 0 | 24 |
| 33 | 70 | 56 | n.d. | 0 | 48 |

n.d. = not determined

Oleyl acetate, applied with the active ingredient according to the method of invention, appears to have a fine synergizing effect on Spinosad on Musca domestica L.

### Example 20: Activity on Blatta orientalis

Method: Contact test on non-porous tile measuring 400 cm² at a temperature of 21° C. Test duration: up to 144 hours after exposure of the insect to the insecticidal active substance.

Cockroaches used for testing: 10.

Six tests were performed in parallel, A, B, C, D, E and F, as follows:
A) Comparative. 1 ml of Composition 4a was distributed on the tile. After waiting for the complete evaporation of the solvent, 10 cockroaches were placed on top of the treated tile, starting the test.
B) According to the invention. 1 ml of Composition 25b was distributed on a tile. After waiting for the complete evaporation of the solvent, 1 ml of Composition 4a was added to the same tile. Subsequently, after waiting for the solvent to evaporate, 10 cockroaches were placed on top of the treated tile, starting the test.
C) According to the invention. 1 ml of Composition 25b was distributed on a tile. After waiting for the complete evaporation of the solvent, 10 cockroaches were placed for 30 minutes on top of the treated tile. At the end of the 30 minutes, the cockroaches were transferred to an untreated area. After waiting 3 hours, a new tile was treated with 1 ml of Composition 4a and, after evaporation of the solvent, the cockroaches that had previously come into contact with said Composition 25b were repositioned on the tile, starting the test.
D) According to the invention. 1 ml of Composition 29 was distributed on a tile. After waiting for the complete evaporation of the solvent, 1 ml of Composition 4a was added to the same tile. Subsequently, after waiting for the solvent to evaporate, 10 cockroaches were placed on top of the treated tile, starting the test.
E) According to the invention. 1 ml of Composition 30 was distributed on a tile. After waiting for the complete evaporation of the solvent, 10 cockroaches were placed for 30 minutes on top of the treated tile. At the end of the 30 minutes, the cockroaches were transferred to an untreated area. After waiting 3 hours, a new tile was treated with 1 ml of Composition 4a and, after evaporation of the solvent, the cockroaches that had previously come into contact with said Composition 30 were repositioned on the tile, starting the test.
F) According to the invention. 1 ml of Composition 30 was distributed on a tile. After waiting for the complete evaporation of the solvent, 1 ml of Composition 4a was added to the same tile. Subsequently, after waiting for the solvent to evaporate, 10 cockroaches were placed on top of the treated tile, starting the test. Each experiment (A-F) was conducted in duplicate.

A control test was carried out in parallel by placing cockroaches on an untreated tile.

TABLE 20

| (A) | (B) | (C) | (D) | (E) | (F) | Control | |
|---|---|---|---|---|---|---|---|
| Mortality | Mortality | Mortality | Mortality | Mortality | Mortality | Mortality | Time |
| % | % | % | % | % | % | % | (h) |
| 5 | 100 | 70 | 25 | 55 | 15 | 0 | 24 |
| 25 | 100 | 90 | 60 | 65 | 20 | 0 | 72 |
| n.d. | 100 | n.d. | n.d. | n.d. | n.d. | 0 | 120 |
| n.d | 100 | n.d. | 75 | 80 | 60 | 0 | 144 |

n.d. = not determined

Oleyl acetate (B, C), dodecyl acetate (D), n-Octyl acetate (E, F) applied with the active ingredient according to the method of invention, appears to have an excellent-fine synergizing effect on Cypermethrin on Blatta orientalis.

### Example 21: Activity on Blatta orientalis

Method: Contact test on non-porous tile measuring 400 cm² at a temperature of 25° C. Test duration: up to 48 hours after exposure of the insect to the insecticidal active substance.

Cockroaches used for testing: 10.

Two tests were performed in parallel, A and B, as follows:
A) Comparative. 1 ml of Composition 23b was distributed on the tile. After waiting for the complete evaporation of the solvent, 10 cockroaches were placed on top of the treated tile, starting the test.
B) According to the invention. 1 ml of Composition 27b was distributed on a tile. After waiting for the complete evaporation of the solvent, 1 ml of Composition 23b was added to the same tile. Subsequently, after waiting for the solvent to evaporate, 10 cockroaches were placed on top of the treated tile, starting the test.

Each experiment (A-B) was conducted in duplicate.

A control test was carried out in parallel by placing cockroaches on an untreated tile.

TABLE 21

| (A) | (B) | Control | |
|---|---|---|---|
| Mortality | Mortality | Mortality | Time |
| % | % | % | (h) |
| 17 | 60 | 0 | 48 |

Oleyl acetate applied with the active ingredient according to the method of invention, appears to have a fine synergizing effect on Azamethiphos on Blatta orientalis.

### Example 22: Activity on Blatta lateralis

Method: Contact test on non-porous tile measuring 400 cm² at a temperature of 25° C. Test duration: up to 48 hours after exposure of the insect to the insecticidal active substance.

Cockroaches used for testing: 10.

Two tests were performed in parallel, A and B, as follows:
A) Comparative. 1 ml of Composition 24 was distributed on the tile. After waiting for the complete evaporation of the solvent, 10 cockroaches were placed on top of the treated tile, starting the test.
B) According to the invention. 1 ml of Composition 28 was distributed on a tile. After waiting for the complete evaporation of the solvent, 1 ml of Composition 24 was added to the same tile. Subsequently, after waiting for the solvent to evaporate, 10 cockroaches were placed on top of the treated tile, starting the test. Each experiment (A-B) was conducted in duplicate.

A control test was carried out in parallel by placing cockroaches on an untreated tile.

TABLE 22

| (A) | (B) | Control | |
|---|---|---|---|
| Mortality | Mortality | Mortality | Time |
| % | % | % | (h) |
| 20 | 97 | 0 | 48 |

Oleyl acetate applied with the active ingredient according to the method of invention, appears to have an excellent synergizing effect on Imidacloprid on Blatta lateralis.

### Example 23: Activity on Musca domestica L

Method used: Contact test on non-porous tile measuring 400 cm² at a temperature of 25° C.

Test duration: up to 48 hours after exposure of the insect to the insecticidal active substance.

N° flies used for testing: 10.

Four tests were performed in parallel, A, B, C and D, as follows:
A) Comparative. 1 ml of Composition 43 was distributed on the tile. After waiting for the complete evaporation of the solvent, 10 flies were placed on top of the treated tile, starting the test.
B) According to the invention. 1 ml of Composition 22a was distributed on a tile. After waiting for the complete evaporation of the solvent, 1 ml of Composition 43 was added to the same tile. Subsequently, after waiting for the solvent to evaporate, 10 flies were placed on top of the treated tile, starting the test.
C) According to the invention. 1 ml of Composition 22b was distributed on a tile. After waiting for the complete evaporation of the solvent, 1 ml of Composition 43 was added to the same tile. Subsequently, after waiting for the solvent to evaporate, 10 flies were placed on top of the treated tile, starting the test.
D) According to the invention. 1 ml of Composition 22c was distributed on a tile. After waiting for the complete evaporation of the solvent, 1 ml of Composition 43 was added to the same tile. Subsequently, after waiting for the solvent to evaporate, 10 flies were placed on top of the treated tile, starting the test.

Each experiment (A-D) was conducted in duplicate.

A control test was carried out in parallel by placing the flies on an untreated tile.

TABLE 23

| (A) | (B) | (C) | (D) | Control | |
|---|---|---|---|---|---|
| Mortality | Mortality | Mortality | Mortality | Mortality | Time |
| % | % | % | % | % | (h) |
| 27 | 11 | 64 | 17 | 0 | 24 |
| 33 | 48 | 76 | n.d. | 0 | 48 |

n.d. = not determined

Dioctyl carbonate, applied with the active ingredient according to the method of invention, appears to have a fine synergizing effect on Spinosad on Musca domestica L.

### Example 24: Activity on Musca domestica L

Method: Contact test on non-porous tile measuring 400 cm² at a temperature of 25° C. Test duration: up to 24 hours after exposure of the insect to the insecticidal active substance.

Flies used for testing: 10.

Two tests were performed in parallel, A and B, as follows:
A) Comparative. 1 ml of Composition 23a was distributed on the tile. After waiting for the complete evaporation of the solvent, 10 flies were placed on top of the treated tile, starting the test.
B) According to the invention. 1 ml of Composition 44a was distributed on a tile. After waiting for the complete evaporation of the solvent, 1 ml of Composition 23a was added to the same tile. Subsequently, after waiting for the solvent to evaporate, 10 flies were placed on top of the treated tile, starting the test.

Each experiment (A-B) was conducted in duplicate.

A control test was carried out in parallel by placing the flies on an untreated tile.

TABLE 24

| (A) | (B) | Control | |
|---|---|---|---|
| Mortality | Mortality | Mortality | Time |
| % | % | % | (h) |
| 10 | 100 | 0 | 24 |

Dioctyl carbonate, applied with the active ingredient according to the method of invention, appears to have an excellent synergizing effect on Azamethiphos on Musca domestica

### Example 25: Activity on Blatta orientalis

Method: Contact test on non-porous tile measuring 400 cm² at a temperature of 21° C. Test duration: up to 72 hours after exposure of the insect to the insecticidal active substance.

Cockroaches used for testing: 10.

Two tests were performed in parallel, A and B, as follows:
A) Comparative. 1 ml of Composition 23b was distributed on the tile. After waiting for the complete evaporation of the solvent, 10 cockroaches were placed on top of the treated tile, starting the test.
B) According to the invention. 1 ml of Composition 44b was distributed on a tile. After waiting for the complete evaporation of the solvent, 1 ml of Composition 23b was added to the same tile. Subsequently, after waiting for the solvent to evaporate, 10 cockroaches were placed on top of the treated tile, starting the test.

Each experiment (A-B) was conducted in duplicate.

A control test was carried out in parallel by placing cockroaches on an untreated tile.

TABLE 25

| (A) | (B) | Control | |
|---|---|---|---|
| Mortality | Mortality | Mortality | Time |
| % | % | % | (h) |
| 10 | 40 | 0 | 24 |
| 17 | 77 | 0 | 48 |
| 23 | 87 | 0 | 72 |

Dioctyl carbonate, applied with the active ingredient according to the method of invention, appears to have a good synergizing effect on Azamethiphos on Blatta orientalis.

### Example 26: Activity on Blatta lateralis

Method: Contact test on non-porous tile measuring 400 cm² at a temperature of 25° C. Test duration: up to 48 hours after exposure of the insect to the insecticidal active substance.

Cockroaches used for testing: 10.

Two tests were performed in parallel, A and B, as follows:
A) Comparative. 1 ml of Composition 24 was distributed on the tile. After waiting for the complete evaporation of the solvent, 10 cockroaches were placed on top of the treated tile, starting the test.
B) According to the invention. 1 ml of Composition 21 was distributed on a tile. After waiting for the complete evaporation of the solvent, 1 ml of Composition 24 was added to the same tile. Subsequently, after waiting for the solvent to evaporate, 10 cockroaches were placed on top of the treated tile, starting the test.

Each experiment (A-B) was conducted in duplicate.

A control test was carried out in parallel by placing cockroaches on an untreated tile.

TABLE 26

| (A) | (B) | Control | |
|---|---|---|---|
| Mortality | Mortality | Mortality | Time |
| % | % | % | (h) |
| 20 | 73 | 0 | 48 |

Dioctyl carbonate, applied with the active ingredient according to the method of invention, appears to have a good synergizing effect on Imidacloprid on Blatta lateralis.

### Example 27: Activity on Musca domestica L

Method: Contact test on non-porous tile measuring 400 cm² at a temperature of 25° C. Test duration: up to 48 hours after exposure of the insect to the insecticidal active substance.

Flies used for testing: 10.

Three tests were performed in parallel, A, B and C, as follows:
A) Comparative. 1 ml of Composition 43 was distributed on the tile. After waiting for the complete evaporation of the solvent, 10 flies were placed on top of the treated tile, starting the test.
B) According to the invention. 1 ml of Composition 33 was distributed on a tile. After waiting for the complete evaporation of the solvent, 1 ml of Composition 43 was added to the same tile. Subsequently, after waiting for the solvent to evaporate, 10 flies were placed on top of the treated tile, starting the test.
C) According to the invention. 1 ml of Composition 33 was distributed on a tile. After waiting for the complete evaporation of the solvent, 10 flies were placed for 30 minutes on top of the treated tile. At the end of the 30 minutes, the flies were transferred to an untreated area. After waiting 3 hours, a new tile was treated with 1 ml of Composition 43 and, after evaporation of the solvent, the flies that had previously come into contact with said Composition 33 were repositioned on the tile, starting the test.

Each experiment (A-C) was conducted in duplicate.

A control test was carried out in parallel by placing the flies on an untreated tile.

TABLE 27

| (A) | (B) | (C) | Control | |
|---|---|---|---|---|
| Mortality | Mortality | Mortality | Mortality | Time |
| % | % | % | % | (h) |
| 27 | 84 | 16 | 0 | 24 |
| 33 | 89 | 37 | 0 | 48 |

1,2-hexandiol, applied with the active ingredient according to the method of invention, appears to have a good synergizing effect on Spinosad on Musca domestica L.

### Example 28: Activity on Musca domestica L

Method: Contact test on non-porous tile measuring 400 cm² at a temperature of 25° C. Test duration: up to 48 hours after exposure of the insect to the insecticidal active substance.

Flies used for testing: 10.

Three tests were performed in parallel, A, B and C, as follows:
A) Comparative. 1 ml of Composition 1 was distributed on the tile. After waiting for the complete evaporation of the solvent, 10 flies were placed on top of the treated tile, starting the test.
B) According to the invention. 1 ml of Composition 34 was distributed on a tile. After waiting for the complete evaporation of the solvent, 1 ml of Composition 1 was added to the same tile. Subsequently, after waiting for the solvent to evaporate, 10 flies were placed on top of the treated tile, starting the test.
C) According to the invention. 1 ml of Composition 34 was distributed on a tile. After waiting for the complete evaporation of the solvent, 10 flies were placed for 30 minutes on top of the treated tile. At the end of the 30 minutes, the flies were transferred to an untreated area. After waiting 3 hours, a new tile was treated with 1 ml of Composition 1 and, after evaporation of the solvent, the flies that had previously come into contact with said Composition 34 were repositioned on the tile, starting the test.

Each experiment (A-C) was conducted in duplicate.

A control test was carried out in parallel by placing the flies on an untreated tile.

TABLE 28

| (A) | (B) | (C) | Control | |
|---|---|---|---|---|
| Mortality | Mortality | Mortality | Mortality | Time |
| % | % | % | % | (h) |
| 70 | 97 | 84 | 0 | 24 |
| 73 | 97 | 100 | 0 | 48 |

1,2-hexandiol, applied with the active ingredient according to the method of invention, appears to have a good synergizing effect on Pyrethrins on Musca domestica L.

### Example 29: Activity on Musca domestica L

Method used: Contact test on non-porous tile measuring 400 cm² at a temperature of 25° C.

Test duration: up to 48 hours after exposure of the insect to the insecticidal active substance.

Flies used for testing: 10.

Nine tests were performed in parallel, A, B, C, D, E, F, G, H and I, as follows:
A) Comparative. 1 ml of Composition 3 was distributed on the tile. After waiting for the complete evaporation of the solvent, 10 flies were placed on top of the treated tile, starting the test.
B) According to the invention. 1 ml of Composition 31a was distributed on a tile. After waiting for the complete evaporation of the solvent, 1 ml of Composition 3 was added to the same tile. Subsequently, after waiting for the solvent to evaporate, 10 flies were placed on top of the treated tile, starting the test.
C) According to the invention. 1 ml of Composition 31b was distributed on a tile. After waiting for the complete evaporation of the solvent, 1 ml of Composition 3 was added to the same tile. Subsequently, after waiting for the solvent to evaporate, 10 flies were placed on top of the treated tile, starting the test.
D) According to the invention. 1 ml of Composition 31b was distributed on a tile. After waiting for the complete evaporation of the solvent, 10 flies were placed for 30 minutes on top of the treated tile. At the end of the 30 minutes, the flies were transferred to an untreated area. After waiting 3 hours, a tile was treated with 1 ml of Composition 3 and, after evaporation of the solvent, the flies that had previously come into contact with said Composition 31b were repositioned on the tile, starting the test.
E) According to the invention. 1 ml of Composition 38a was distributed on a tile. After waiting for the complete evaporation of the solvent, 1 ml of Composition 3 was added to the same tile. Subsequently, after waiting for the solvent to evaporate, 10 flies were placed on top of the treated tile, starting the test.
F) According to the invention. 1 ml of Composition 38a was distributed on a tile. After waiting for the complete evaporation of the solvent, 10 flies were placed for 30 minutes on top of the treated tile. At the end of the 30 minutes, the flies were transferred to an untreated area. After waiting 3 hours, a new tile was treated with 1 ml of Composition 3 and, after evaporation of the solvent, the flies that had previously come into contact with said Composition 38a were repositioned on the tile, starting the test.

G) According to the invention. 1 ml of Composition 40a was distributed on a tile. After waiting for the complete evaporation of the solvent, 1 ml of Composition 3 was added to the same tile. Subsequently, after waiting for the solvent to evaporate, 10 flies were placed on top of the treated tile, starting the test.

H) According to the invention. 1 ml of Composition 41a was distributed on a tile. After waiting for the complete evaporation of the solvent, 1 ml of Composition 3 was added to the same tile. Subsequently, after waiting for the solvent to evaporate, 10 flies were placed on top of the treated tile, starting the test.
I) According to the invention. 1 ml of Composition 41a was distributed on a tile. After waiting for the complete evaporation of the solvent, 10 flies were placed for 30 minutes on top of the treated tile. At the end of the 30 minutes, the flies were transferred to an untreated area. After waiting 3 hours, a new tile was treated with 1 ml of Composition 3 and, after evaporation of the solvent, the flies that had previously come into contact with said Composition 41a were repositioned on the tile, starting the test.

Each experiment (A-I) was conducted in duplicate.

A control test was carried out in parallel by placing the flies on an untreated tile.

TABLE 29a

| (A) | (B) | (C) | (D) | Control | |
|---|---|---|---|---|---|
| Mortality | Mortality | Mortality | Mortality | Mortality | Time |
| % | % | % | % | % | (h) |
| 10 | 90 | 100 | 80 | 0 | 24 |
| 16 | 90 | 100 | 86 | 0 | 48 |

TABLE 29b

| (E) | (F) | (G) | (H) | (I) | Control | |
|---|---|---|---|---|---|---|
| Mortality | Mortality | Mortality | Mortality | Mortality | Mortality | Time |
| % | % | % | % | % | % | (h) |
| 24 | 5 | 10 | 4 | 13 | 0 | 24 |
| 38 | 14 | 32 | 16 | 17 | 0 | 48 |

1,2-hexandiol, applied with the active ingredient according to the method of invention, appears to have an excellent synergizing effect on Cypermethrin on Musca domestica L. also when was used a very low w/w ratio.

### Example 30: Activity on Musca domestica L

Method: Contact test on non-porous tile measuring 400 cm² at a temperature of 25° C. Test duration: up to 48 hours after exposure of the insect to the insecticidal active substance.

Flies used for testing: 10.

Two tests were performed in parallel, A and B, as follows:
A) Comparative. 1 ml of Composition 23a was distributed on the tile. After waiting for the complete evaporation of the solvent, 10 flies were placed on top of the treated tile, starting the test.
B) According to the invention. 1 ml of Composition 32 was distributed on a tile. After waiting for the complete evaporation of the solvent, 1 ml of Composition 23a was added to the same tile. Subsequently, after waiting for the solvent to evaporate, 10 flies were placed on top of the treated tile, starting the test.

Each experiment (A-B) was conducted in duplicate.

A control test was carried out in parallel by placing the flies on an untreated tile.

TABLE 30

| (A) | (B) | Control | |
|---|---|---|---|
| Mortality | Mortality | Mortality | Time |
| % | % | % | (h) |
| 10 | 100 | 0 | 24 |
| 23 | 100 | 0 | 48 |

1,2-hexandiol, applied with the active ingredient according to the method of invention, appears to have an excellent synergizing effect on Azamethiphos on Musca domestica L.

### Example 31: Activity on Blatta lateralis

Method: Contact test on non-porous tile measuring 400 cm² at a temperature of 25° C. Test duration: up to 72 hours after exposure of the insect to the insecticidal active substance.

Cockroaches used for testing: 10.

Four tests were performed in parallel, A, B, C and D, as follows:
A) Comparative. 1 ml of Composition 4b was distributed on the tile. After waiting for the complete evaporation of the solvent, 10 cockroaches were placed on top of the treated tile, starting the test.
B) According to the invention. 1 ml of Composition 31c was distributed on a tile. After waiting for the complete evaporation of the solvent, 1 ml of Composition 4b was added to the same tile. Subsequently, after waiting for the solvent to evaporate, 10 cockroaches were placed on top of the treated tile, starting the test.
C) According to the invention. 1 ml of Composition 31d was distributed on a tile. After waiting for the complete evaporation of the solvent, 1 ml of Composition 4b was added to the same tile. Subsequently, after waiting for the solvent to evaporate, 10 cockroaches were placed on top of the treated tile, starting the test.
D) According to the invention. 1 ml of Composition 31d was distributed on a tile. After waiting for the complete evaporation of the solvent, 10 cockroaches were placed for 30 minutes on top of the treated tile. At the end of the 30 minutes, the cockroaches were transferred to an untreated area. After waiting 3 hours, a new tile was treated with 1 ml of Composition 4b and, after evaporation of the solvent, the cockroaches that had previously come into contact with said Composition 31d were repositioned on the tile, starting the test.

Each experiment (A-D) was conducted in duplicate.

A control test was carried out in parallel by placing cockroaches on an untreated tile.

TABLE 31

| (A) | (B) | (C) | (D) | Control | |
|---|---|---|---|---|---|
| Mortality | Mortality | Mortality | Mortality | Mortality | Time |
| % | % | % | % | % | (h) |
| 0 | 57 | 63 | 0 | 0 | 24 |
| 40 | 100 | 73 | 83 | 0 | 48 |
| n.d. | n.d. | 77 | 87 | 0 | 72 |

n.d. = not determined

1,2-hexandiol, applied with the active ingredient according to the method of invention, appears to have a good synergizing effect on Cypermethrin on Blatta lateralis.

### Example 32: Activity on Blatta orientalis

Method: Contact test on non-porous tile measuring 400 cm² at a temperature of 25° C. Test duration: up to 144 hours after exposure of the insect to the insecticidal active substance.

Cockroaches used for testing: 10.

Seven tests were performed in parallel, A, B, C, D, E, F and G, as follows:
A) Comparative. 1 ml of Composition 4a was distributed on the tile. After waiting for the complete evaporation of the solvent, 10 cockroaches were placed on top of the treated tile, starting the test.
B) According to the invention. 1 ml of Composition 38b was distributed on a tile. After waiting for the complete evaporation of the solvent, 1 ml of Composition 4a was added to the same tile. Subsequently, after waiting for the solvent to evaporate, 10 cockroaches were placed on top of the treated tile, starting the test.
C) According to the invention. 1 ml of Composition 38b was distributed on a tile. After waiting for the complete evaporation of the solvent, 10 cockroaches were placed for 30 minutes on top of the treated tile. At the end of the 30 minutes, the cockroaches were transferred to an untreated area. After waiting 3 hours, a tile was treated with 1 ml of Composition 4a and, after evaporation of the solvent, the cockroaches that had previously come into contact with said Composition 38b were repositioned on the tile, starting the test.
D) According to the invention. 1 ml of Composition 39 was distributed on a tile. After waiting for the complete evaporation of the solvent, 1 ml of Composition 4a was added to the same tile. Subsequently, after waiting for the solvent to evaporate, 10 cockroaches were placed on top of the treated tile, starting the test.
E) According to the invention. 1 ml of Composition 41b was distributed on a tile. After waiting for the complete evaporation of the solvent, 1 ml of Composition 4a was added to the same tile. Subsequently, after waiting for the solvent to evaporate, 10 cockroaches were placed on top of the treated tile, starting the test.
F) According to the invention. 1 ml of Composition 41b was distributed on a tile. After waiting for the complete evaporation of the solvent, 10 cockroaches were placed for 30 minutes on top of the treated tile. At the end of the 30 minutes, the cockroaches were transferred to an untreated area. After waiting 3 hours, a tile was treated with 1 ml of Composition 4a and, after evaporation of the solvent, the cockroaches that had previously come into contact with said Composition 41b were repositioned on the tile, starting the test.

G) According to the invention. 1 ml of Composition 45 was distributed on a tile. After waiting for the complete evaporation of the solvent, 1 ml of Composition 4a was added to the same tile. Subsequently, after waiting for the solvent to evaporate, 10 cockroaches were placed on top of the treated tile, starting the test.

Each experiment (A-G) was conducted in duplicate.

A control test was carried out in parallel by placing cockroaches on an untreated tile.

TABLE 32a

| (A) | (B) | (C) | (D) | Control | |
|---|---|---|---|---|---|
| Mortality | Mortality | Mortality | Mortality | Mortality | Time |
| % | % | % | % | % | (h) |
| 10 | 50 | 40 | 65 | 0 | 24 |
| 35 | 100 | 55 | 70 | 0 | 48 |
| 45 | 100 | 100 | n.d. | 0 | 72 |
| n.d. | 100 | 100 | 100 | 0 | 120 |

TABLE 32b

| (E) | (F) | (G) | Control | |
|---|---|---|---|---|
| Mortality | Mortality | Mortality | Mortality | Time |
| % | % | % | % | (h) |
| 60 | 70 | 0 | 0 | 24 |
| 85 | 85 | 25 | 0 | 48 |
| n.d. | 100 | 25 | 0 | 72 |
| 100 | 100 | n.d. | 0 | 120 |
| 100 | 100 | 75 | 0 | 144 |

Different 1,2 and 1,12 alkane diols, applied with the active ingredient according to the method of invention, appears to have a good-excellent synergizing effect on Cypermethrin on Blatta orientalis.

### Example 33: Activity on Blatta lateralis

Method: Contact test on non-porous tile measuring 400 cm² at a temperature of 25° C. Test duration: up to 48 hours after exposure of the insect to the insecticidal active substance.

Cockroaches used for testing: 10.

Four tests were performed in parallel, A, B, C and D, as follows:
A) Comparative. 1 ml of Composition 24 was distributed on the tile. After waiting for the complete evaporation of the solvent, 10 cockroaches were placed on top of the treated tile, starting the test.
B) According to the invention. 1 ml of Composition 35 was distributed on a tile. After waiting for the complete evaporation of the solvent, 1 ml of Composition 24 was added to the same tile. Subsequently, after waiting for the solvent to evaporate, 10 cockroaches were placed on top of the treated tile, starting the test.
C) According to the invention. 1 ml of Composition 40b was distributed on a tile. After waiting for the complete evaporation of the solvent, 1 ml of Composition 24 was added to the same tile. Subsequently, after waiting for the solvent to evaporate, 10 cockroaches were placed on top of the treated tile, starting the test.
D) According to the invention. 1 ml of Composition 42 was distributed on a tile. After waiting for the complete evaporation of the solvent, 1 ml of Composition 24 was added to the same tile. Subsequently, after waiting for the solvent to evaporate, 10 cockroaches were placed on top of the treated tile, starting the test.

Each experiment (A-D) was conducted in duplicate.

A control test was carried out in parallel by placing cockroaches on an untreated tile.

TABLE 33

| (A) | (B) | (C) | (D) | Control | |
|---|---|---|---|---|---|
| Mortality | Mortality | Mortality | Mortality | Mortality | Time |
| % | % | % | % | % | (h) |
| 20 | 100 | 23 | 23 | 0 | 48 |

1,2-hexandiol (B), applied with the active ingredient according to the method of invention, has an excellent synergizing effect on Imidacloprid on Blatta lateralis.

### Example 34: Activity on Blattella germanica

Method: Contact test on non-porous tile measuring 400 cm² at a temperature of 25° C. Test duration: up to 24 hours after exposure of the insect to the insecticidal active substance.

Cockroaches used for testing: 10.

Two tests were performed in parallel, A and B, as follows:
A) Comparative. 1 ml of Composition 36 was distributed on the tile. After waiting for the complete evaporation of the solvent, 10 cockroaches were placed on top of the treated tile, starting the test.
B) According to the invention. 1 ml of Composition 37 was distributed on a tile. After waiting for the complete evaporation of the solvent, 1 ml of Composition 36 was added to the same tile. Subsequently, after waiting for the solvent to evaporate, 10 cockroaches were placed on top of the treated tile, starting the test.

Each experiment (A-B) was conducted in duplicate.

A control test was carried out in parallel by placing cockroaches on an untreated tile.

TABLE 34

| (A) | (B) | Control | |
|---|---|---|---|
| Mortality | Mortality | Mortality | Time |
| % | % | % | (h) |
| 27 | 50 | 0 | 24 |

Alcohol oleic 95%, applied with the active ingredient according to the method of invention, appears to have a fine synergizing effect on Imidacloprid on Blattella germanica.

### Example 35: Activity on Musca domestica L

Method: Contact test on non-porous tile measuring 400 cm² at a temperature of 25° C. Test duration: up to 48 hours after exposure of the insect to the insecticidal active substance.

Flies used for testing: 10.

Three tests were performed in parallel, A, B and C, as follows:
A) Comparative. 1 ml of Composition 46a was distributed on the tile. After waiting for the complete evaporation of the solvent, 10 flies were placed on top of the treated tile, starting the test.
B) According to the invention. 1 ml of Composition 11a was distributed on a tile. After waiting for the complete evaporation of the solvent, 1 ml of Composition 46a was added to the same tile. Subsequently, after waiting for the solvent to evaporate, 10 flies were placed on top of the treated tile, starting the test.
C) According to the invention. 1 ml of Composition 11a was distributed on a tile. After waiting for the complete evaporation of the solvent, 10 flies were placed for 30 minutes on top of the treated tile. At the end of the 30 minutes, the flies were transferred to an untreated area. After waiting 3 hours, a new tile was treated with 1 ml of Composition 46a and, after evaporation of the solvent, the flies that had previously come into contact with said Composition 11a were repositioned on the tile, starting the test.

Each experiment (A-C) was conducted in duplicate.

A control test was carried out in parallel by placing the flies on an untreated tile.

TABLE 35

| (A) | (B) | (C) | Control | |
|---|---|---|---|---|
| Mortality | Mortality | Mortality | Mortality | Time |
| % | % | % | % | (h) |
| 5 | 78 | 70 | 0 | 24 |
| 10 | 78 | 70 | 0 | 48 |

Oleic alcohol 95%, applied with half dose of the active ingredient according to the method of invention, appears to have a good synergizing effect on Cypermethrin on Musca domestica L.

### Example 36: Activity on Blatta orientalis

Method: Contact test on non-porous tile measuring 400 cm² at a temperature of 25° C. Test duration: up to 48 hours after exposure of the insect to the insecticidal active substance.

Cockroaches used for testing: 10.

Three tests were performed in parallel, A, B and C, as follows:
A) Comparative. 1 ml of Composition 46b was distributed on the tile. After waiting for the complete evaporation of the solvent, 10 cockroaches were placed on top of the treated tile, starting the test.
B) According to the invention. 1 ml of Composition 11b was distributed on a tile. After waiting for the complete evaporation of the solvent, 1 ml of Composition 46b was added to the same tile. Subsequently, after waiting for the solvent to evaporate, 10 cockroaches were placed on top of the treated tile, starting the test.
C) According to the invention. 1 ml of Composition 11b was distributed on a tile. After waiting for the complete evaporation of the solvent, 10 cockroaches were placed for 30 minutes on top of the treated tile. At the end of the 30 minutes, the cockroaches were transferred to an untreated area. After waiting 3 hours, a new tile was treated with 1 ml of Composition 46b and, after evaporation of the solvent, the cockroaches that had previously come into contact with said Composition 11b were repositioned on the tile, starting the test.

Each experiment (A-C) was conducted in duplicate.

A control test was carried out in parallel by placing the cockroaches on an untreated tile.

TABLE 36

| (A) | (B) | (C) | Control | |
|---|---|---|---|---|
| Mortality | Mortality | Mortality | Mortality | Time |
| % | % | % | % | (h) |
| 8 | 60 | 40 | 0 | 24 |
| 17 | 100 | 77 | 0 | 48 |

Oleic alcohol 95%, applied with half dose of the active ingredient according to the method of invention, appears to have a fine synergizing effect on Cypermethrin on Blatta orientalis.

To highlight the surprising results according to the present invention, the data are collected and summarised in the following tables 37 and 38.

TABLE 37
Blatta sp. death rate after exposure to the indicated active ingredients at different concentrations,
in the presence or in the absence of the indicated alcohol or alcohol derivative.

| | Active | | Mortality %/ | Synergist/active | Synergist/active |
|---|---|---|---|---|---|
| | ingredient | Synergist | time (h) | ingredient | ingredient |
| Insect | (mg/ml) | (mg/ml) | (application)¹ | (molar ratio) | (w/w ratio) |
| Blatta | Cypermethrin | — | 40/48 | — | — |
| lateralis | (0.03) | | | | |
| Blatta | — | 1,2-hexandiol | 14/48 | — | — |
| lateralis | | (0.05) | | | |
| Blatta | Cypermethrin | 1,2-hexandiol | 57/24 (C) | 3.2 | 1.5 |
| lateralis | (0.03) | (0.05) | | | |
| Blatta | Cypermethrin | 1,2-hexandiol | 100/48 (C) | 3.2 | 1.5 |
| lateralis | (0.03) | (0.05) | | | |
| Blatta | — | 1,2-hexandiol | 20/48 | — | — |
| lateralis | | (0.07) | | | |
| Blatta | Cypermethrin | 1,2-hexandiol | 73/48 (C) | 5.0 | 2.3 |
| lateralis | (0.03) | (0.07) | | | |
| Blatta | Cypermethrin | 1,2-hexandiol | 0/24 (R) | 5.0 | 2.3 |
| lateralis | (0.03) | (0.07) | | | |
| Blatta | Cypermethrin | 1,2-hexandiol | 83/48 (R) | 5.0 | 2.3 |
| lateralis | (0.03) | (0.07) | | | |
| Blatta | Cypermethrin | 1,2-hexandiol | 87/72 (R) | 5.0 | 2.3 |
| lateralis | (0.03) | (0.07) | | | |
| Blatta | Cypermethrin | — | 17/48 | — | — |
| orientalis | (0.10) | | | | |
| Blatta | — | Oleic alcohol | 0/48 | — | — |
| orientalis | | 95% (0.30) | | | |
| Blatta | Cypermethrin | Oleic alcohol | 100/48 (C) | 4.7 | 2.9 |
| orientalis | (0.10) | 95% (0.30) | | | |
| Blatta | Cypermethrin | — | 35/48 | — | — |
| orientalis | (0.20) | | | | |
| Blatta | — | 1,2-octandiol | n.d. | — | — |
| orientalis | | (0.30) | | | |
| Blatta | Cypermethrin | 1,2-octandiol | 100/48 (C) | 4.0 | 1.5 |
| orientalis | (0.20) | (0.30) | | | |
| Blatta | Cypermethrin | 1,2-octandiol | 55/48 (R) | 4.0 | 1.5 |
| orientalis | (0.20) | (0.30) | | | |
| Blatta | Cypermethrin | 1,2-octandiol | 100/72 (R) | 4.0 | 1.5 |
| orientalis | (0.20) | (0.30) | | | |
| Blatta | — | 1,8-octandiol | n.d. | — | — |
| orientalis | | (0.30) | | | |
| Blatta | Cypermethrin | 1,8-octandiol | 70/48 (C) | 4.0 | 1.5 |
| orientalis | (0.20) | (0.30) | | | |
| Blatta | Cypermethrin | 1,8-octandiol | 100/120 (C) | 4.0 | 1.5 |
| orientalis | (0.20) | (0.30) | | | |
| Blatta | | 1,2-dodecandiol | n.d. | — | — |
| orientalis | | (0.30) | | | |
| Blatta | Cypermethrin | 1,2-dodecandiol | 100/120 (C) | 3.0 | 1.5 |
| orientalis | (0.20) | (0.30) | | | |
| Blatta | Cypermethrin | 1,2-dodecandiol | 85/48 (R) | 3.0 | 1.5 |
| orientalis | (0.20) | (0.30) | | | |
| Blatta | Cypermethrin | 1,2-dodecandiol | 100/72 (R) | 3.0 | 1.5 |
| orientalis | (0.20) | (0.30) | | | |
| Blatta | — | 1,12-dodecandiol | n.d. | — | — |
| orientalis | | (0.30) | | | |
| Blatta | Cypermethrin | 1,12-dodecandiol | 25/48 (C) | 3.0 | 1.5 |
| orientalis | (0.20) | (0.30) | | | |
| Blatta | Cypermethrin | 1,12-dodecandiol | 25/72 (C) | 3.0 | 1.5 |
| orientalis | (0.20) | (0.30) | | | |
| Blatta | Cypermethrin | 1,12-dodecandiol | 75/144 (C) | 3.0 | 1.5 |
| orientalis | (0.20) | (0.30) | | | |
| Blatta | Cypermethrin | — | 35/48 | — | — |
| orientalis | (0.20) | | | | |
| Blatta | — | 2-ethylexyl | 0/48 | — | — |
| orientalis | | carbonate | | | |
| | | (0.30) | | | |
| Blatta | Cypermethrin | 2-ethylexyl | 50/48 | 2.1 | 1.5 |
| orientalis | (0.20) | carbonate | | | |
| | | (0.30) | | | |
| Blatta | Cypermethrin | — | 35/48 | — | — |
| orientalis | (0.20) | | | | |
| Blatta | — | Dioctyl carbonate | 0/48 | — | — |
| orientalis | | (0.30) | | | |
| Blatta | Cypermethrin | Dioctyl carbonate | 60/48 | 2.1 | 1.5 |
| orientalis | (0.20) | (0.30) | | | |
| Blatta | Cypermethrin | — | 35/48 | — | — |
| orientalis | (0.20) | | | | |
| Blatta | — | Oleic alcohol | 0/48 | — | — |
| orientalis | | 95% (0.30) | | | |
| Blatta | Cypermethrin | Oleic alcohol | 85/48 | 2.2 | 1.5 |
| orientalis | (0.20) | 95% (0.30) | | | |
| Blatta | Cypermethrin | Oleic alcohol | 95/48 (C) | 2.3 | 1.5 |
| orientalis | (0.20) | 85% (0.30) | | | |
| Blatta | Cypermethrin | Oleic alcohol | 100/48 (R) | 2.3 | 1.5 |
| orientalis | (0.20) | 85% (0.30) | | | |
| Blatta | Cypermethrin | — | 20/48 | — | — |
| orientalis | (0.20) | | | | |
| Blatta | — | Octadecanol | n.d. | — | — |
| orientalis | | (0.30) | | | |
| Blatta | Cypermethrin | Octadecanol | 80/72 (C) | 2.3 | 1.5 |
| orientalis | (0.20) | (0.30) | | | |
| Blatta | — | Dodecanol | n.d. | — | — |
| orientalis | | (0.30) | | | |
| Blatta | Cypermethrin | Dodecanol | 95/96 (C) | 3.3 | 1.5 |
| orientalis | (0.20) | (0.30) | | | |
| Blatta | — | Octanol | n.d. | — | — |
| orientalis | | (0.30) | | | |
| Blatta | Cypermethrin | Octanol | 100/96 (C) | 4.8 | 1.5 |
| orientalis | (0.20) | (0.30) | | | |
| Blatta | — | Hexadecanol | n.d. | — | — |
| orientalis | | (0.30) | | | |
| Blatta | Cypermethrin | Hexadecanol | 75/72 (C) | 2.6 | 1.5 |
| orientalis | (0.20) | (0.30) | | | |
| Blatta | — | Tetradecanol | n.d. | — | — |
| orientalis | | (0.30) | | | |
| Blatta | Cypermethrin | Tetradecanol | 100/72 (C) | 3.0 | 1.5 |
| orientalis | (0.20) | (0.30) | | | |
| Blatta | — | 2-octyl dodecanol | n.d. | — | — |
| orientalis | | (0.30) | | | |
| Blatta | Cypermethrin | 2-octyl dodecanol | 90/48 (C) | 2.0 | 1.5 |
| orientalis | (0.20) | (0.30) | | | |
| Blatta | Cypermethrin | — | 35/48 | | |
| orientalis | (0.20) | | | | |
| Blatta | — | Oleyl acetate | 0/48 | — | — |
| orientalis | | (0.30) | | | |
| Blatta | Cypermethrin | Oleyl acetate | 100/24 (C) | 2.0 | 1.5 |
| orientalis | (0.20) | (0.30) | | | |
| Blatta | Cypermethrin | Oleyl acetate | 90/72 (R) | 2.0 | 1.5 |
| orientalis | (0.20) | (0.30) | | | |
| Blatta | — | Dodecyl acetate | n.d. | — | — |
| orientalis | | (0.30) | | | |
| Blatta | Cypermethrin | Dodecyl acetate | 75/144 (C) | 2.7 | 1.5 |
| orientalis | (0.20) | (0.30) | | | |
| Blatta | Cypermethrin | Dodecyl acetate | 85/120 (R) | 2.7 | 1.5 |
| orientalis | (0.20) | (0.30) | | | |
| Blatta | — | n-Octyl acetate | n.d. | — | — |
| orientalis | | (0.30) | | | |
| Blatta | Cypermethrin | n-Octyl acetate | 60/144 (C) | 3.6 | 1.5 |
| orientalis | (0.20) | (0.30) | | | |
| Blatta | Pyrethrins | — | 7/48 (C) | — | — |
| orientalis | (0.40) | | | | |
| Blatta | — | Oleic alcohol | 0/48 | — | — |
| orientalis | | 85% (4.00) | | | |
| Blatta | Pyrethrins | Oleic alcohol | 23/48 (C) | 13.2 | 10.0 |
| orientalis | (0.40) | 85% (4.00) | | | |
| Blatta | Pyrethrins | Oleic alcohol | 44/48 (R) | 13.2 | 10.0 |
| orientalis | (0.40) | 85% (4.00) | | | |
| Blatta | Pyrethrins | — | 50/48 (C) | — | — |
| orientalis | (microincapsulated) | | | | |
| | (0.8) | | | | |
| Blatta | — | Oleic alcohol | 0/48 | — | — |
| orientalis | | 85% (2.96) | | | |
| Blatta | Pyrethrins | Oleic alcohol | 63/48 (C) | 4.6 | 3.5 |
| orientalis | (microincapsulated) | 85% (2.96) | | | |
| | (0.8) | | | | |
| Blatta | Azamethiphos | — | 17/48 | — | — |
| orientalis | (0.46) | | | | |
| Blatta | — | 1,2-hexandiol | 0/48 | — | — |
| orientalis | | (0.84) | | | |
| Blatta | Azamethiphos | 1,2-hexandiol | 17/48 (C) | 5.0 | 1.8 |
| orientalis | (0.46) | (0.84) | | | |
| Blatta | Azamethiphos | — | 17/48 | — | — |
| orientalis | (0.46) | | | | |
| Blatta | — | Oleic alcohol | 0/48 | — | — |
| orientalis | | 95% (1.90) | | | |
| Blatta | Azamethiphos | Oleic alcohol | 50/48 (C) | 6.0 | 5.0 |
| orientalis | (0.46 | 95% (1.90) | | | |
| Blatta | Azamethiphos | — | 17/48 | — | — |
| orientalis | (0.46) | | | | |
| Blatta | — | Oleyl acetate | 0/48 | — | — |
| orientalis | | (2.20) | | | |
| Blatta | Azamethiphos | Oleyl acetate | 60/48 (C) | 5.0 | 4.8 |
| orientalis | (0.46) | (2.20) | | | |
| Blatta | Imidacloprid | — | 20/48 | — | — |
| lateralis | (15.00) | | | | |
| Blatta | — | Oleic alcohol | n.d. | — | — |
| lateralis | | 95% (78.76) | | | |
| Blatta | Imidacloprid | Oleic alcohol | 100/48 (C) | 5.0 | 5.3 |
| lateralis | (15.00) | 95% (78.76) | | | |
| Balta | Imidacloprid | — | 20/48 | | |
| lateralis | (15.00) | | | | |
| Blatta | — | Oleyl acetate | n.d. | | |
| lateralis | | (91.09) | | | |
| Blatta | Imidacloprid | Oleyl acetate | 97/48 (C) | 5.0 | 6.1 |
| lateralis | (15.00) | (91.09) | | | |
| Blatta | Imidacloprid | — | 20/48 | — | — |
| lateralis | (15.00) | | | | |
| Blatta | — | 1,2-hexandiol | n.d. | — | — |
| lateralis | | (34.67) | | | |
| Blatta | Imidacloprid | 1,2-hexandiol | 100/48 (C) | 5.0 | 2.3 |
| lateralis | (15.00) | (34.67) | | | |
| Blatta | — | 1,8-octandiol | n.d. | — | — |
| lateralis | | (42.90) | | | |
| Blatta | Imidacloprid | 1,8-octandiol | 23/48 (C) | 5.0 | 2.9 |
| lateralis | (15.00) | (42.90) | | | |
| Blatta | — | 1,2-dodecandiol | n.d. | — | — |
| lateralis | | (59.36) | | | |
| Blatta | Imidacloprid | 1,2-dodecandiol | 23/48 (C) | 5.0 | 4.0 |
| lateralis | (15.00) | (59.36) | | | |
| Blattella | Imidacloprid | — | 27/24 | — | — |
| germanica | (0.20) | | | | |
| Blattella | — | Oleic alcohol | 7/24 | — | — |
| germanica | | 95% (50.00) | | | |
| Blattella | Imidacloprid | Oleic alcohol | 50/24 (C) | 9.0 | 9.5 |
| germanica | (0.20) | 95% (50.00) | | | |

TABLE 38
Musca domestica death rate after exposure to the indicated actives, in the
presence or in the absence of the indicated alcohol or alcohol derivative.

| | Active | | Mortality %/ | Synergist/active | Synergist/active |
|---|---|---|---|---|---|
| | ingredient | Synergist | time (h) | ingredient | ingredient |
| Insect | (mg/ml) | (mg/ml) | (application)¹ | (molar ratio) | (w/w ratio) |
| Musca | Spinosad | — | 33/48 | — | — |
| domestica | (0.24) | | | | |
| Musca | — | Oleic alcohol | 1/48 | — | — |
| domestica | | 95% (0.15) | | | |
| Musca | Spinosad | Oleic alcohol | 49/48 (C) | 1.7 | 0.6 |
| domestica | (0.24) | 95% (0.15) | | | |
| Musca | — | Oleic alcohol | 5/48 | — | — |
| domestica | | 95% (0.51) | | | |
| Musca | Spinosad | Oleic alcohol | 47/48 (C) | 5.8 | 2.1 |
| domestica | (0.24) | 95% (0.51) | | | |
| Musca | — | Oleic alcohol | 8/48 | — | — |
| domestica | | 95% (0.88) | | | |
| Musca | Spinosad | Oleic alcohol | 86/24 (C) | 11.6 | 3.7 |
| domestica | (0.24) | 95% (0.88) | | | |
| Musca | Spinosad | — | 33/48 | — | — |
| domestica | (0.24) | | | | |
| Musca | — | 1,2-hexandiol | 4/48 | — | — |
| domestica | | (0.39) | | | |
| Musca | Spinosad | 1,2-hexandiol | 84/24 (C) | 10.0 | 1.6 |
| domestica | (0.24) | (0.39) | | | |
| Musca | Spinosad | 1,2-hexandiol | 89/48 (C) | 10.0 | 1.6 |
| domestica | (0.24) | (0.39) | | | |
| Musca | Spinosad | 1,2-hexandiol | 37/48 (R) | 10.0 | 1.6 |
| domestica | (0.24) | (0.39) | | | |
| Musca | Spinosad | — | 33/48 | — | — |
| domestica | (0.24) | | | | |
| Musca | — | Oleyl acetate | 0/48 | — | — |
| domestica | | (0.15) | | | |
| Musca | Spinosad | Oleyl acetate | 70/48 (C) | 1.5 | 0.6 |
| domestica | (0.24) | (0.15) | | | |
| Musca | — | Oleyl acetate | 0/48 | — | — |
| domestica | | (0.51) | | | |
| Musca | Spinosad | Oleyl acetate | 56/48 (C) | 5.0 | 2.1 |
| domestica | (0.24) | (0.51) | | | |
| Musca | — | Oleyl acetate | 0/48 | — | — |
| domestica | | (1.02) | | | |
| Musca | Spinosad | Oleyl acetate | 48/24 (C) | 10.0 | 4.2 |
| domestica | (0.24) | (1.02) | | | |
| Musca | Pyrethrins | — | 73/48 | — | — |
| domestica | (0.70) | | | | |
| Musca | — | 1,2-hexandiol | 23/48 | — | — |
| domestica | | (2.34) | | | |
| Musca | Pyrethrins | 1,2-hexandiol | 97/24 (C) | 10.0 | 3.3 |
| domestica | (0.70) | (2.34) | | | |
| Musca | Pyrethrins | 1,2-hexandiol | 97/48 (C) | 10.0 | 3.3 |
| domestica | (0.70) | (2.34) | | | |
| Musca | Pyrethrins | 1,2-hexandiol | 84/24 (R) | 10.0 | 3.3 |
| domestica | (0.70) | (2.34) | | | |
| Musca | Pyrethrins | 1,2-hexandiol | 100/48 (R) | 10.0 | 3.3 |
| domestica | (0.70) | (2.34) | | | |
| Musca | Pyrethrins | — | 73/48 | — | — |
| domestica | (0.70) | | | | |
| Musca | — | Oleic alcohol | 0/48 | — | — |
| domestica | | 85% (7.00) | | | |
| Musca | Pyrethrins | Oleic alcohol | 94/48 (C) | 13.0 | 10.0 |
| domestica | (0.70) | 85% (7.00) | | | |
| Musca | Pyrethrins | Oleic alcohol | 90/48 (R) | 13.0 | 10.0 |
| domestica | (0.70) | 85% (7.00) | | | |
| Musca | Pyrethrin | — | 65/48 | — | — |
| domestica | (microencapsulated) | | | | |
| | (1.00) | | | | |
| Musca | — | Oleic alcohol | 0/48 | — | — |
| domestica | | 85% (3.70) | | | |
| Musca | Pyrethrin | Oleic alcohol | 87/48(C) | 4.6 | 3.5 |
| domestica | (microencapsulated) | 85% (3.70) | | | |
| | (1.00) | | | | |
| Musca | Cypermethrin | — | 10/48 | — | — |
| domestica | (0.23) | | | | |
| Musca | — | Oleic alcohol | 6/48 | — | — |
| domestica | | 95% (0.68) | | | |
| Musca | Cypermethrin | Oleic alcohol | 78/48 (C) | 4.7 | 2.9 |
| domestica | (0.23) | 95% (0.68) | | | |
| Musca | Cypermethrin | — | 16/48 | — | — |
| domestica | (0.45) | | | | |
| Musca | — | Oleic alcohol | 0/48 | — | — |
| domestica | | 85% (0.68) | | | |
| Musca | Cypermethrin | Oleic alcohol | 40/48 (C) | 2.3 | 1.5 |
| domestica | (0.45) | 85% (0.68) | | | |
| Musca | Cypermethrin | Oleic alcohol | 70/48 (R) | 2.3 | 1.5 |
| domestica | (0.45) | 85% (0.68) | | | |
| Musca | Cypermethrin | — | 16/48 | — | — |
| domestica | (0.45) | | | | |
| Musca | — | 2-octyl | 20/48 | — | — |
| domestica | | dodecanol | | | |
| | | (0.68) | | | |
| Musca | Cypermethrin | 2-octyl | 60/48 (C) | 2.0 | 1.5 |
| domestica | (0.45) | dodecanol | | | |
| | | (0.68) | | | |
| Musca | — | Dodecanol | 4/48 | — | — |
| domestica | | (0.68) | | | |
| Musca | Cypermethrin | Dodecanol | 58/48 (C) | 3.3 | 1.5 |
| domestica | (0.45) | (0.68) | | | |
| Musca | Cypermethrin | — | 16/48 | — | — |
| domestica | (0.45) | | | | |
| Musca | — | 1,2-hexandiol | 7/48 | — | — |
| domestica | | (0.68) | | | |
| Musca | Cypermethrin | 1,2-hexandiol | 90/24 (C) | 3.2 | 1.5 |
| domestica | (0.45) | (0.68) | | | |
| Musca | Cypermethrin | 1,2-hexandiol | 90/48 (C) | 3.2 | 1.5 |
| domestica | (0.45) | (0.68) | | | |
| Musca | — | 1,2-hexandiol | 10/48 | — | — |
| domestica | | (1.05) | | | |
| Musca | Cypermethrin | 1,2-hexandiol | 100/24 (C) | 5.0 | 2.3 |
| domestica | (0.45) | (1.05) | | | |
| Musca | Cypermethrin | 1,2-hexandiol | 100/48 (C) | 5.0 | 2.3 |
| domestica | (0.45) | (1.05) | | | |
| Musca | Cypermethrin | 1,2-hexandiol | 80/24 (R) | 5.0 | 2.3 |
| domestica | (0.45) | (1.05) | | | |
| Musca | Cypermethrin | 1,2-hexandiol | 86/48 (R) | 5.0 | 2.3 |
| domestica | (0.45) | (1.05) | | | |
| Musca | — | 1,2-octandiol | 0/48 | — | — |
| domestica | | (0.68) | | | |
| Musca | Cypermethrin | 1,2-octandiol | 38/48 (C) | 4.6 | 1.5 |
| domestica | (0.45) | (0.68) | | | |
| Musca | Cypermethrin | 1,2-octandiol | 14/48 (R) | 4.6 | 1.5 |
| domestica | (0.45) | (0.68) | | | |
| Musca | — | 1,8-octandiol | 0/48 | — | — |
| domestica | | (0.68) | | | |
| Musca | Cypermethrin | 1,8-octandiol | 32/48 (C) | 4.6 | 1.5 |
| domestica | (0.45) | (0.68) | | | |
| Musca | — | 1,2- | 0/48 | — | — |
| domestica | | dodecandiol | | | |
| | | (0.68) | | | |
| Musca | Cypermethrin | 1,2- | 16/48 (C) | 3.3 | 1.5 |
| domestica | (0.45) | dodecandiol | | | |
| | | (0.68) | | | |
| Musca | Cypermethrin | 1,2- | 17/48 (R) | 3.3 | 1.5 |
| domestica | (0.45) | dodecandiol | | | |
| | | (0.68) | | | |
| Musca | Cypermethrin | — | 16/48 | — | — |
| domestica | (0.45) | | | | |
| Musca | — | Oleyl acetate | 60/48 | — | — |
| domestica | | (0.68) | | | |
| Musca | Cypermethrin | Oleyl acetate | 89/48 (C) | 2.0 | 1.5 |
| domestica | (0.45) | (0.68) | | | |
| Musca | Cypermethrin | — | 16/48 | — | — |
| domestica | (0.45) | | | | |
| Musca | — | 2-ethylexyl | 19/48 | — | — |
| domestica | | carbonate | | | |
| | | (0.68) | | | |
| Musca | Cypermethrin | 2-ethylexyl | 90/48 | 2.4 | 1.5 |
| domestica | (0.45) | carbonate | | | |
| | | (0.68) | | | |
| Musca | Cypermethrin | — | 16/48 | — | — |
| domestica | (0.45) | | | | |
| Musca | | Dioctyl | 33/48 | — | — |
| domestica | | carbonate | | | |
| | | (0.68) | | | |
| Musca | Cypermethrin | Dioctyl | 90/48 | 2.4 | 1.5 |
| domestica | (0.45) | carbonate | | | |
| | | (0.68) | | | |
| Musca | Cypermethrin | — | 16/48 | — | — |
| domestica | (0.45) | | | | |
| Musca | — | Oleic alcohol | 6/48 | — | — |
| domestica | | 95% (0.68) | | | |
| Musca | Cypermethrin | Oleic alcohol | 60/48 | 2.5 | 1.5 |
| domestica | (0.45) | 95% (0.68) | | | |
| Musca | Azamethiphos | — | 23/48 | — | — |
| domestica | (6.90) | | | | |
| Musca | — | 1,2-hexandiol | n.d. | — | — |
| domestica | | (12.56) | | | |
| Musca | Azamethiphos | 1,2-hexandiol | 100/24 (C) | 5.0 | 1.8 |
| domestica | (6.90) | (12.56) | | | |
| Musca | Azamethiphos | — | 23/48 | — | — |
| domestica | (6.90) | | | | |
| Musca | — | Oleyl acetate | 18/48 | — | — |
| domestica | | (33.00) | | | |
| Musca | Azamethiphos | Oleyl acetate | 100/24 (C) | 5.0 | 4.8 |
| domestica | (6.90) | (33.00) | | | |
| Musca | Azamethiphos | — | 23/48 | — | — |
| domestica | (6.90) | | | | |
| Musca | — | Oleic alcohol | 18/48 | — | — |
| domestica | | 95% (28.53) | | | |
| Musca | Azamethiphos | Oleic alcohol | 100/24 (C) | 5.8 | 4.8 |
| domestica | (6.90) | 95% (28.53) | | | |

¹method of application at the same time (C) or after 3 h (R).

1. An insecticidal composition comprising:
(i) an active ingredient which is at least one component with adulticidal and/or larvicidal insecticidal activity and/or at least one component with insect growth regulating activity; and
(ii) an least one synergist which is a linear or branched, saturated or unsaturated hydrocarbon alcohol having from 6 to 24 carbon atoms or a carbonate or ester thereof.

2. The composition according to claim 1, where said active substance is at least one member selected from the group consisting of a natural pyrethrin, a synthetic pyrethrin, neonicotinoid, a biopesticide a, spinosine, a phosphoric ester, an oxadiazine, a phenylpyrazole, an avermectin, Neem oil, or a pure azadirachtin.

3. The composition according to claim 1, wherein said at least one hydrocarbon alcohol is an alcohol of formula (I) 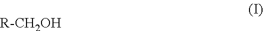
where R is a hydrocarbon chain having from 5 to 23 carbon atoms, optionally substituted, said chain being linear or branched, saturated or unsaturated, or a carbonate or ester thereof.

4. The composition according to claim 3, wherein one or more of said carbon atoms on said R chain are optionally substituted with one or more OH groups.

5. The composition according to claim 3, where said carbonate or ester thereof is selected from the group consisting of an ester of formula (II) 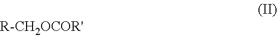
where R′ is a linear or branched, saturated or unsaturated alkyl radical, having from 1 to 6 carbon atoms, where one or more of said carbon atoms on said R′ chain are optionally substituted with one or more OH groups,
a carbonate of formula (III) 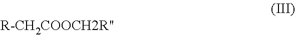
where R″ is equal to or different from R and if it is different, it is a linear or branched, saturated or unsaturated alkyl radical, having from 1 to 23 carbon atoms, with optionally one or more of said carbon atoms being OH substituted.

6. The composition according to claim 1, where the synergist is present in said composition in a weight ratio of 0.4 to 20 with respect to the at least one active ingredient.

7. The composition according to claim 1, where the synergist is present in said composition in a weight ratio of less than with respect to the at least one active ingredient.

8. (canceled)

9. A method for insect pest control which comprises exposing an area of interest, or a target insect, to at least one synergist which is an alcohol of formula (I) as defined in claim 1, and to at least one active principle with adulticidal and/or larvicidal insecticidal activity and/or regulating the growth of insects.

10. The method according to claim 9, wherein said method comprises exposing said area of interest or said target insect to said at least one synergist and said at least one pesticide for a time ranging from 0 to up to 5 hours, where exposure to said synergist precedes exposure to said at least one pesticide, when said exposures are not simultaneous.

11. The method according to claim 9, wherein said exposure to said at least one synergist and said at least one pesticide occurs simultaneously.

12. The method according to claim 9, where said exposure to said at least one synergist precedes exposure to said at least one pesticide by a time of up to 5 hours.

13. The method according to claim 12, where said exposure to said at least one synergist prior to said exposure to said at least one pesticided is obtained by inserting said at least one pesticide inside an encapsulated part of a formulation and said at least one synergist in a free part of the same formulation.

14. The method according to claim 9, wherein said target insect is Musca domestica, said active ingredient is selected from the group consisting of Cypermethrin, Spinosad, a synthetic or natural pyrethrin, Azamethiphos, and said alcohol or alcohol derivative is selected from the group consisting of 1,2-hexandiol, 2-ethylexyl carbonate, dioctyl carbonate, oleyl acetate, oleic alcohol, 2-octyl dodecanol, dodecanol, 1,2-octandiol, and 1,8-octandiol.

15. The method according to claim 9, wherein said target insect is of the genus Blatta sp., said active ingredient is selected from the group consisting of Cypermethrin, Imidacloprid, a synthetic or natural pyrethrin, Azamethiphos and said alcohol or alcohol derivative is selected from the group consisting of 1,2-hexandiol, 2-ethylexyl carbonate, dioctyl carbonate, oleyl acetate, oleic alcohol, dodecanol, and 1,2-octandiol.

16. The composition according to claim 1, where said active substance is at least one member selected from the group consisting of Cypermethrin, Permethrin, Deltamethrin, Tetramethrin, Prallethrin, Imidacloprid, and Azamethiphos.

17. The composition according to claim 1, wherein said at least one hydrocarbon alcohol is an alcohol of formula (I) 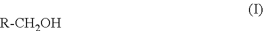
where R is a hydrocarbon chain having from 7 to 19 carbon atoms, optionally substituted, said chain being linear or branched, saturated or unsaturated, or a carbonate or ester thereof.

18. The method according to claim 9, wherein said method comprises exposing said area of interest or said target insect to said at least one synergist and said at least one pesticide for a time ranging from 0 to 3 hours, where exposure to said synergist precedes exposure to said at least one pesticide, when said exposures are not simultaneous.

19. The method according to claim 9, where said exposure to said at least one synergist precedes exposure to said at least one pesticide by a time of up to 3 hours.

20. The method according to claim 9, where said exposure to said at least one synergist precedes exposure to said at least one pesticide by a time of up to 1 hour.
